(19) United States
(12) Patent Application Publication
(10) Pub. No.: US 2023/0246190 A1
(43) Pub. Date: Aug. 3, 2023

(54) GRAPHENE COMPOUND, SECONDARY BATTERY, MOVING VEHICLE, AND ELECTRONIC DEVICE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Kanta ABE, Atsugi-shi, Kanagawa (JP); Daichi HIGO, Atsugi-shi, Kanagawa (JP)

(21) Appl. No.: 18/001,349

(22) PCT Filed: Jun. 7, 2021
(86) PCT No.: PCT/IB2021/054950

§ 371 Date: Dec. 9, 2022

(30) Foreign Application Priority Data
Jun. 19, 2020 (JP) 2020-106145

(51) Int. Cl. H01M 4/583; H01M 4/133; C01B 32/194

(52) U.S. Cl. CPC H01M 4/5835; H01M 4/133; C01B 32/194; C01B 2204/22; C01P 2002/77; C01P 2002/78

(57) ABSTRACT

A carbon material with excellent characteristics is provided. An electrode having excellent characteristics can be provided. A novel carbon material can be provided. A novel electrode can be provided. A graphene compound including a vacancy includes a plurality of carbon atoms and one or more fluorine atoms, and the vacancy is formed with the plurality of carbon atoms and one or more fluorine atoms. The vacancy includes a ring-shaped region composed of the plurality of carbon atoms, and one or more fluorine atoms terminated in the ring-shaped region, and the ring-shaped region is a 18- or more-membered ring.

### TECHNICAL FIELD

The present invention relates to graphene and a manufacturing method thereof. The present invention relates to a secondary battery and a manufacturing method thereof. The present invention relates to a moving vehicle such as a vehicle and a portable information terminal each including a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

In addition to the stability of a secondary battery, the high capacity of a secondary battery is important. A silicon-based material has high capacity and is used as an active material of a secondary battery. A silicon material can be characterized by a chemical shift value obtained from an NMR spectrum (Patent Document 1).

### REFERENCE

### Patent Document

### [Patent Document 1]

Japanese Published Patent Application No. 2015-156355

### SUMMARY OF THE INVENTION

### Problems to be Solved by the Invention

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used in portable terminals and the like are demanded. Therefore, secondary batteries used for portable terminals are demanded to have higher capacity.

For example, an electrode of a secondary battery is formed using materials such as an active material, a conductive agent, and a binder. As the proportion of a material that contributes to charge-discharge capacity, for example, an active material, becomes higher, a secondary battery can have increased capacity. When an electrode includes a conductive agent, the conductivity of the electrode is increased and excellent output characteristics can be obtained. Repeated expansion and contraction of an active material in charging and discharging of a secondary battery may cause collapse of the active material, short-circuiting of a conductive path, or the like in the electrode. In such a case, one or both of a conductive agent and a binder included in an electrode can suppress at least one of the collapse of an active material and short-circuiting of a conductive path. Meanwhile, the use of a conductive agent or a binder lowers the proportion of an active material, which might decrease the capacity of a secondary battery in some cases.

An object of one embodiment of the present invention is to provide a carbon material with excellent characteristics. Another object of one embodiment of the present invention is to provide an electrode having excellent characteristics. Another object of one embodiment of the present invention is to provide a novel carbon material. Another object of one embodiment of the present invention is to provide a novel electrode.

Another object of one embodiment of the present invention is to provide a durable negative electrode. Another object of one embodiment of the present invention is to provide a durable positive electrode. Another object of one embodiment of the present invention is to provide a negative electrode with high conductivity. Another object of one embodiment of the present invention is to provide a positive electrode with high conductivity.

Another object of one embodiment of the present invention is to provide a secondary battery with little deterioration. Another object of one embodiment of the present invention is to provide a highly safe secondary battery. Another object of one embodiment of the present invention is to provide a novel secondary battery.

Another object of one embodiment of the present invention is to provide a novel material, novel active material particles, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

A graphene compound including graphene is capable of making low-resistance surface contact; accordingly, the electrical conduction between an active material in the form of particles and the graphene compound can be improved with a smaller amount of the graphene compound than that of a normal conductive agent. This can increase the proportion of the active material in the active material layer. Thus, discharge capacity of the secondary battery can be increased.

A graphene compound can cling to an active material like fermented soybeans (natto). By providing a graphene compound as a bridge between a plurality of active materials and an electrolyte, it is possible to not only form an excellent conductive path in the electrode but also bind or fix the materials. In addition, for example, a three-dimensional net-like structure is formed by using a graphene compound, and materials such as the electrolyte, the plurality of active materials, and like are placed in meshes, whereby the graphene compound forms a three-dimensional conductive path and detachment of an active material from the electrode can be suppressed. Thus, the graphene compound can function both as a conductive agent and a binder in the electrode.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In an electrode, a graphene compound can cling to an active material. The active material includes a region covered with the graphene compound.

The graphene compound of one embodiment of the present invention preferably includes a vacancy in part of a carbon sheet. In the graphene compound of one embodiment of the present invention, a vacancy through which carrier ions such as lithium ions can pass is provided in part of a carbon sheet, which can facilitate insertion and extraction of carrier ions in the surface of an active material covered with the graphene compound to increase the rate characteristics of a secondary battery. The vacancy provided in part of the carbon sheet is referred to as a hole, a defect, or a gap in some cases.

Here, the vacancy included in the carbon sheet of the graphene compound is preferably so small that a reduction in the conductivity is suppressed.

A graphene compound of one embodiment of the present invention preferably includes a vacancy formed with a plurality of carbon atoms and one or more fluorine atoms terminating the carbon atoms. Furthermore, the graphene compound of one embodiment of the present invention includes a plurality of carbon atoms and one or more fluorine atoms, the plurality of carbon atoms are preferably bonded to each other in a ring and one or more of the plurality of carbon atoms bonded in a ring are preferably terminated by the fluorine atoms.

Fluorine has high electronegativity and is easily negatively charged. Approach of positively-charged lithium ions causes interaction, and thereby energy is stable and the barrier energy in passage of lithium ions through a vacancy can be lowered. Thus, fluorine contained in a vacancy in a graphene compound allows a lithium ion to easily pass through even the vacancy with a small size; therefore, the graphene compound can have excellent conductivity.

A graphene compound of one embodiment of the present invention includes a region in which 7 or more carbon atoms, preferably 18 or more carbon atoms, further preferably 22 or more carbon atoms are bonded to each other in a ring, and one or more of the carbon atoms bonded in a ring are terminated by fluorine. The graphene compound of one embodiment of the present invention may include two or more regions in which 18 or more carbon atoms, preferably 22 or more carbon atoms are bonded to each other in a ring.

A graphene compound of one embodiment of the present invention includes a vacancy formed with a many-membered ring which is a 7- or more-membered ring composed of carbon, preferably a 18- or more-membered ring composed of carbon, or further preferably a 22- or more-membered ring composed of carbon and in which one or more of the carbon atoms are terminated by fluorine.

A graphene compound of one embodiment of the present invention includes a ring composed of carbon, and the size of the ring is 0.6 nm or more, preferably 0.7 nm or more, further preferably 0.75 nm or more, still further preferably 0.8 nm or more in diameter of a circle obtained by conversion. The graphene compound of one embodiment of the present invention may include a plurality of the rings composed of carbon. In the graphene compound of one embodiment of the present invention, a lithium ion can pass through the ring.

One embodiment of the present invention is a graphene compound including a vacancy, in which the graphene compound includes a plurality of carbon atoms and one or more fluorine atoms terminating the carbon atoms, and the vacancy is formed with the plurality of carbon atoms and the one or more fluorine atoms.

In the above structure, the vacancy includes a ring-shaped region composed of the plurality of carbon atoms, and the one or more fluorine atoms terminated in the ring-shaped region, and the ring-shaped region is a 18- or more-membered ring.

In the above structure, preferably, a lithium ion can pass through the ring-shaped region.

In the above structure, a change in a stabilization energy when the lithium ion passes through the vacancy is preferably 1 eV or less.

In the above structure, the stabilization energy is preferably obtained by a Nudged Elastic Band method.

Another embodiment of the present invention is a secondary battery that includes an electrolyte and an electrode including the graphene described in any of the above structures and an active material.

Another embodiment of the present invention is a moving vehicle including the above-described secondary battery.

Another embodiment of the present invention is an electronic device including the above-described secondary battery.

### Effect of the Invention

A carbon material with excellent characteristics can be provided. According to one embodiment of the present invention, an electrode having excellent characteristics can be provided. According to another embodiment of the present invention, a novel carbon material can be provided. According to another embodiment of the present invention, a novel electrode can be provided.

According to another embodiment of the present invention, a durable negative electrode can be provided. According to another embodiment of the present invention, a durable positive electrode can be provided. According to another embodiment of the present invention, a negative electrode with high conductivity can be provided. According to another embodiment of the present invention, a positive electrode with high conductivity can be provided.

According to another embodiment of the present invention, a secondary battery with less deterioration can be provided. According to another embodiment of the present invention, a highly safe secondary battery can be provided. According to another embodiment of the present invention, a novel secondary battery can be provided.

According to another embodiment of the present invention, a novel material, novel active material particles, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A is a diagram illustrating an example of a cross section of a secondary battery. FIG. 1B is a diagram illustrating an example of a cross section of a negative electrode.

FIG. 2 is a diagram illustrating an example of a cross section of a negative electrode.

FIG. 3 is a schematic cross-sectional view of multilayer graphene and an active material.

FIG. 4A, FIG. 4B, and FIG. 4C are diagrams each illustrating an example of a graphene compound.

FIG. 5A, FIG. 5B, and FIG. 5C are diagrams each illustrating an example of a graphene compound.

FIG. 6A, FIG. 6B, and FIG. 6C are diagrams each illustrating a vacancy included in a graphene compound.

FIG. 7A and FIG. 7B are diagrams illustrating an example of a graphene compound.

FIG. 8A and FIG. 8B are diagrams illustrating an example of a graphene compound.

FIG. 9A and FIG. 9B are diagrams illustrating an example of a graphene compound.

FIG. 10A and FIG. 10B are diagrams illustrating an example of a graphene compound.

FIG. 11A and FIG. 11B are diagrams illustrating an example of a graphene compound.

FIG. 12A and FIG. 12B are diagrams illustrating an example of a graphene compound.

FIG. 13A and FIG. 13B are diagrams each illustrating an example of a graphene compound.

FIG. 14 is a diagram illustrating an example of a graphene compound.

FIG. 15A and FIG. 15B are diagrams each showing calculation results of energy.

FIG. 16 is a diagram illustrating crystal structures of a positive electrode active material.

FIG. 17 is a diagram illustrating crystal structures of a positive electrode active material.

FIG. 18 is a diagram illustrating an example of a cross section of a secondary battery.

FIG. 19A is an exploded perspective view of a coin-type secondary battery, FIG. 19B is a perspective view of the coin-type secondary battery, and FIG. 19C is a cross-sectional perspective view of the coin-type secondary battery.

FIG. 20A and FIG. 20B illustrate an example of a cylindrical secondary battery, and FIG. 20C and FIG. 20D illustrate examples of power storage systems including a plurality of cylindrical secondary batteries.

FIG. 21A and FIG. 21B illustrate examples of a secondary battery and FIG. 21C is a diagram illustrating the inside of a secondary battery.

FIG. 22A, FIG. 22B, and FIG. 22C are diagrams illustrating examples of secondary batteries.

FIG. 23A and FIG. 23B are external views of a secondary battery.

FIG. 24A, FIG. 24B, and FIG. 24C are diagrams illustrating a method for forming a secondary battery.

FIG. 25A is a perspective view of a battery pack, FIG. 25B is a block diagram of the battery pack, and FIG. 25C is a block diagram of a vehicle including a motor.

FIG. 26A to FIG. 26D are diagrams illustrating examples of transport vehicles.

FIG. 27A and FIG. 27B are diagrams illustrating of a power storage.

FIG. 28A to FIG. 28D are diagrams illustrating examples of electronic devices.

FIG. 29A and FIG. 29B are diagrams illustrating an example of a graphene compound.

FIG. 30A and FIG. 30B are diagrams each showing calculation results of energy.

FIG. 31A to FIG. 31G are diagrams each illustrating an example of a graphene compound.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

### Embodiment 1

In this embodiment, a secondary battery, an electrode, and the like according to one embodiment of the present invention will be described.

One embodiment of the present invention is a secondary battery including a positive electrode and a negative electrode. Examples of the secondary battery include a lithium-ion battery.

### <Example of Electrode>

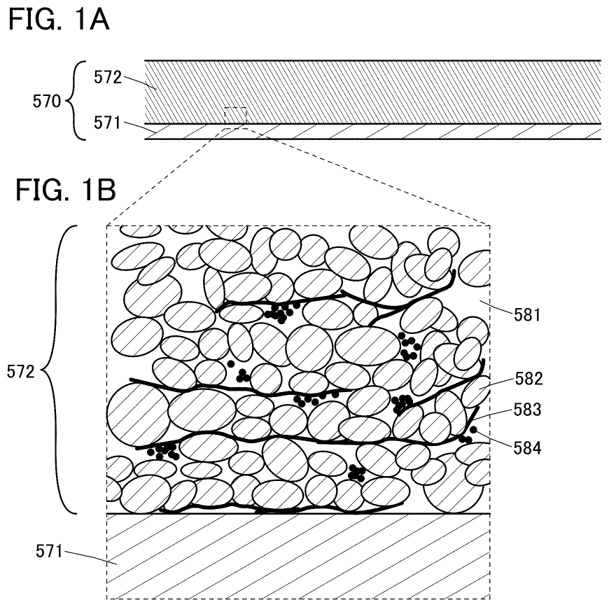

FIG. 1A is a schematic cross-sectional view illustrating an electrode of one embodiment of the present invention. An electrode 570 illustrated in FIG. 1A can be applied to a positive electrode and a negative electrode included in a secondary battery. The electrode 570 includes at least a current collector 571 and an active material layer 572 formed in contact with the current collector 571.

FIG. 1B is an enlarged view of a region surrounded by a dashed line in FIG. 1A. As illustrated in FIG. 1B, the active material layer 572 includes an electrolyte 581 and an active material 582. A variety of materials can be used as the active material 582. A material that can be used as the material 582 will be described later. A particle is preferably used as the active material.

The active material layer 572 preferably contains a carbon-based material such as graphene compound, carbon black, graphite, carbon fiber, or fullerene, and especially a graphene compound is preferred. As the carbon black, acetylene black (AB) can be used, for example. As the graphite, natural graphite or artificial graphite such as mesocarbon microbeads can be used, for example. These carbon-based materials each have high conductivity and can function as a conductive agent in the active material layer. These carbon-based materials may each function as an active material. FIG. 1B illustrates an example in which the active material layer 572 contains a graphene compound 583 and AB 584.

As carbon fiber, mesophase pitch-based carbon fiber and isotropic pitch-based carbon fiber can be used, for example. Other examples of carbon fiber include carbon nanofiber and carbon nanotube. Carbon nanotube can be formed by, for example, a vapor deposition method.

The active material layer may contain as a conductive agent one or more selected from metal powder and metal fiber of copper, nickel, aluminum, silver, gold, or the like, a conductive ceramic material, and the like.

The content of the conductive agent to the total amount of the active material layer is preferably greater than or equal to 1 wt % and less than or equal to 10 wt %, and further preferably greater than or equal to 1 wt % and less than or equal to 5 wt %.

Unlike a conductive material in the form of particles, such as carbon black, which makes point contact with an active material, the graphene compound is capable of making low-resistance surface contact; accordingly, the electrical conduction between the particles of the positive electrode active material and the graphene compound can be improved with a smaller amount of the graphene compound than that of a normal conductive material. This can increase the proportion of the active material in the active material layer. This can increase discharge capacity of a secondary battery.

Furthermore, a graphene compound of one embodiment of the present invention has excellent permeability to lithium, and can thus increase the charge and discharge rate of a secondary battery.

A compound containing particulate carbon such as carbon black or graphite and a compound containing fibrous carbon such as carbon nanotube easily enter a microscopic space. When a carbon-containing compound that easily enters a microscopic space and a compound containing sheet-like carbon, such as graphene, that can impart conductivity to a plurality of particles are used in combination, the density of the electrode is increased and an excellent conductive path can be formed. When the secondary battery includes an electrolyte of one embodiment of the present invention, the secondary battery can be operated more stably. That is, the secondary battery of one embodiment of the present invention can have both high energy density and stability, and is useful as an in-vehicle secondary battery. When a vehicle becomes heavier with increasing number of secondary batteries, more energy is required to move the vehicle, which shortens the driving range. With the use of a high-density secondary battery, the driving range of the vehicle can be maintained with almost no change in the total weight of a vehicle equipped with a secondary battery having the same weight.

Since more electric power is needed to charge a secondary battery with higher capacity in the vehicle, the secondary battery is desirably charged in a short time. What is called a regenerative charging, in which electric power is temporarily generated when the vehicle is braked and the electric power is used for charging, is performed under high rate charging conditions; thus, a secondary battery for a vehicle is desired to have favorable rate characteristics.

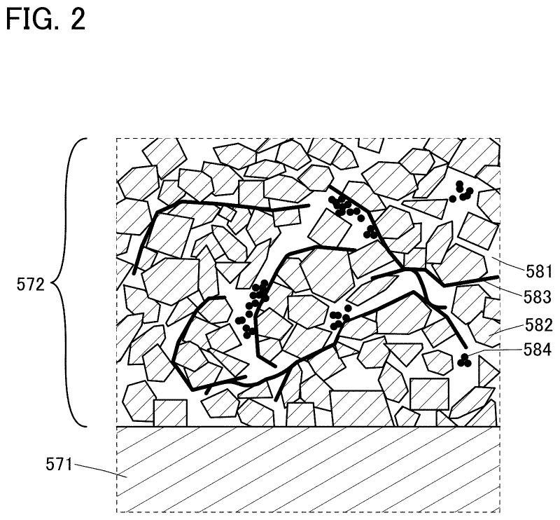

In the active material layer 572 illustrated in FIG. 1B, a plurality of graphene compounds 583 are arranged so that the planes thereof face each other, and the active material 582 is positioned between the plurality of graphene compounds 583. Alternatively, as in the active material layer 572 illustrated in FIG. 2, graphene compounds may be arranged in a three-dimensional net-like shape.

With the use of an electrolyte of one embodiment of the present invention, an in-vehicle secondary battery having a wide temperature range can be obtained.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The active material layer 572 preferably includes a binder (not illustrated). The binder binds or fixes the electrolyte and the active material, for example. In addition, the binder can bind or fix the electrolyte and a carbon-based material, the active material and a carbon-based material, a plurality of active materials, a plurality of carbon-based materials, or the like.

For the binder, an incombustible high molecular material or a nonflammable high molecular material is preferably used. For example, a fluorine polymer which is a high molecular material containing fluorine, specifically, polyvinylidene fluoride (PVDF) can be used. PVDF is a resin having a melting point in the range of higher than or equal to 134° C. and lower than or equal to 169° C., and is a material with excellent thermal stability. As another binder, a polyamide resin, a polycarbonate resin, a polyvinyl chloride resin, a polyphenylene oxide resin, or the like can be used.

In this specification, “nonflammability” refers to a property of not catching fire at all even when a high molecular material is ignited in the combustion test standard such as the UL94 standard or with an oxygen index (OI) of JIS. In addition, “incombustibility” refers to a property of hardly causing a chemical reaction even when a high molecular material is ignited in the combustion test standard such as the UL94 standard or with an oxygen index (OI) of JIS.

The graphene compound 583 can cling to the active material 582 like fermented soybeans. For example, the active material 582 and the graphene compound 583 can be likened to a soybean and a sticky ingredient, respectively. By providing the graphene compound 583 as a bridge between materials included in the active material layer 572, such as the electrolyte, the plurality of active materials, and the plurality of carbon-based materials, it is possible to not only form an excellent conductive path in the active material layer 572 but also bind or fix the materials with use of the graphene compound 583. In addition, for example, a three-dimensional net-like structure is formed by using a plurality of graphene compounds 583, and materials such as the electrolyte, the plurality of active materials, and the plurality of carbon-based materials are placed in meshes, whereby the graphene compounds 583 form a three-dimensional conductive path and detachment of an electrolyte from the current collector can be suppressed. Thus, the graphene compound 583 functions as a conductive agent and may also function as a binder in the active material layer 572.

The active material 582 can have any of various shapes such as a rounded shape and an angular shape. In addition, on the cross section of the electrode, the active material 582 can have any of various cross-sectional shapes such as a circle, an ellipse, a shape having a curved surface, and a polygon. For example, FIG. 1B illustrates an example in which the cross section of the active material 582 has a rounded shape as an example; however, as illustrated in FIG. 2, the cross section of the active material 582 may be angular, for example. Alternatively, one part may be rounded and another part may be angular.

### <Graphene Compound>

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

An electrode of one embodiment of the present invention preferably contains a graphene compound provided with a vacancy. A graphene compound of one embodiment of the present invention includes a region in which 7 or more carbon atoms, preferably 18 or more carbon atoms, further preferably 22 or more carbon atoms are bonded in a ring, and one or more of the carbon atoms bonded in a ring are terminated by fluorine. Moreover, a graphene compound of one embodiment of the present invention may include two or more regions in which 18 or more carbon atoms, preferably 22 or more carbon atoms are bonded in a ring.

The graphene compound of one embodiment of the present invention includes a vacancy formed with a many-membered ring which is a 7- or more-membered ring composed of carbon, preferably a 18- or more-membered ring composed of carbon, or further preferably a 22- or more-membered ring composed of carbon and in which one or more of the carbon atoms are terminated by fluorine.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. One sheet of the reduced graphene oxide can function but a plurality of sheets thereof may be stacked. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

Reducing a graphene oxide can form a vacancy in a graphene compound in some cases.

Furthermore, a material in which an end portion of graphene is terminated by fluorine may be used.

In the longitudinal cross section of the active material layer, the sheet-like graphene compounds are preferably dispersed substantially uniformly in a region inside the active material layer. The plurality of graphene compounds are formed to partly cover the plurality of particles of the active material or adhere to the surfaces thereof, so that the graphene compounds make surface contact with the particles of the active material.

Here, the plurality of graphene compounds can be bonded to each other to form a net-like graphene compound sheet (also referred to as a graphene compound net or a graphene net). A graphene net that covers the active material can function as a binder for bonding the active material particles. A graphene net that covers the active material can function as a binder for bonding the active materials. Accordingly, the amount of the binder can be reduced, or the binder does not have to be used. This can increase the proportion of the active material in the electrode volume and the electrode weight. That is to say, the charge and discharge capacity of the secondary battery can be increased.

Here, preferably, graphene oxide is used as the graphene compound and mixed with an active material to form a layer to be the active material layer, and then reduction is performed. In other words, the formed active material layer preferably contains reduced graphene oxide. When a graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conduction path. Note that the graphene oxide can be reduced by heat treatment or with the use of a reducing agent, for example.

With a spray dry apparatus, a graphene compound serving as a conductive material can be formed in advance as a coating film to cover the entire surface of the active material, and the active materials are electrically connected to each other by the graphene compound to form a conduction path.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

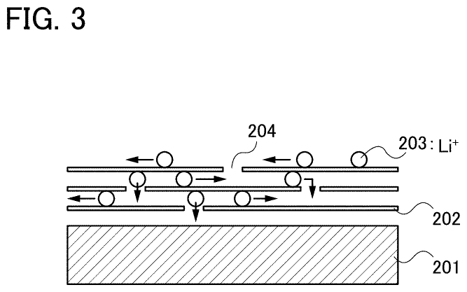

When a graphene compound has a plurality of layers like multilayer graphene or modified multilayer graphene, a vacancy may be provided in each layer. An example is illustrated in the schematic view of FIG. 3. When a lithium ion move in a plane of a graphene compound 202 by charging and discharging and reaches a vacancy 204, the lithium ion moves down to the lower layer of the graphene compound in the case where an electrode 201 (an active material in a secondary battery) in contact with the graphene compound 202 and has a negative potential. On the other hand, in the case where the electrode 201 has a positive potential, the lithium ion moves to the upper layer of the graphene compound.

Although one lithium ion is illustrated as a lithium ion in FIG. 3 and the like for simplicity, the actual number of lithium is not one and a group of a plurality of lithium moves in an electrolyte. A solvent is considered to be solvated in the group of the plurality of lithium, for example. This is a concept that has not been described in conventional known literatures nor conventional books (including textbooks and the like) and is a new model of solvation that is discovered by the present inventors. Furthermore, it is considered that the way of solvation is different based on the number of fluorine bonded, depending on an electrolyte containing fluorine to be used.

### [Calculation]

Energy calculation is performed on a stacked structure of graphene and a stacked structure of graphene and graphene having a vacancy.

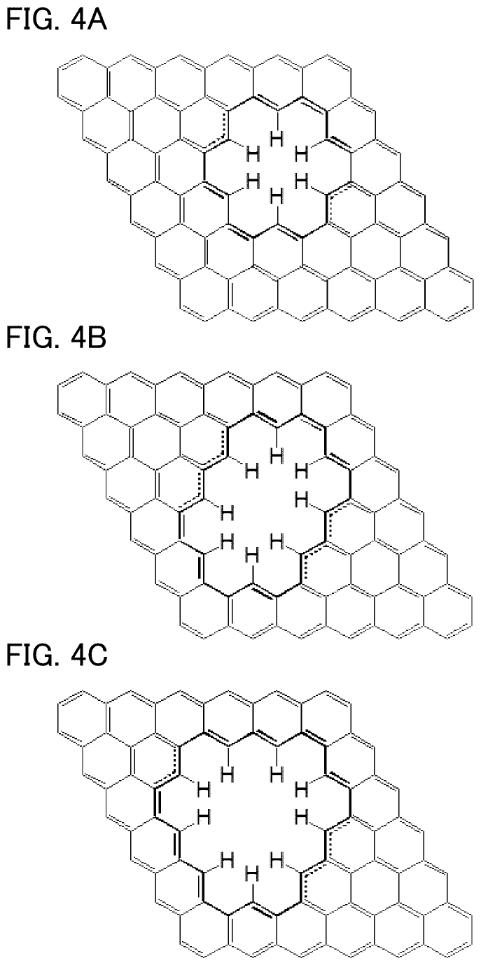

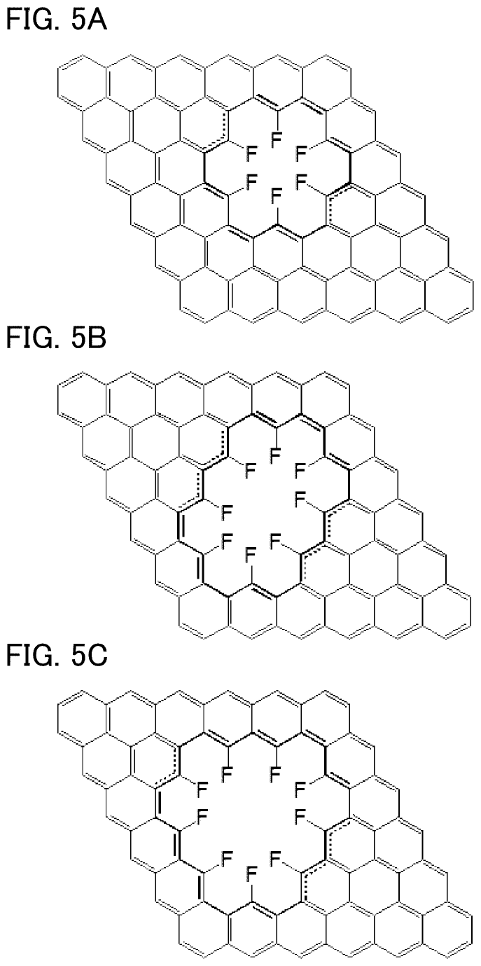

Structures of graphene provided with a vacancy are illustrated in FIG. 4A, FIG. 4B, FIG. 4C, FIG. 5A, FIG. 5B, and FIG. 5C.

In FIG. 4A, graphene includes a vacancy composed of 18 carbon atoms bonded in a ring. Six carbon atoms of the 18 carbon atoms each have a bond with hydrogen. In FIG. 4A, the 18-membered ring composed of carbon atoms is illustrated and six carbon atoms of the carbon atoms included in the 18-membered ring are each terminated by hydrogen. In the structure illustrated in FIG. 4A, one six-membered ring is removed from graphene and carbon atoms bonded to the removed six-membered ring are terminated by hydrogen.

In FIG. 4B, graphene includes a vacancy composed of 22 carbon atoms bonded in a ring. Eight carbon atoms of the 22 carbon atoms each have a bond with hydrogen. In FIG. 4B, the 22-membered ring of carbon atoms is illustrated and eight carbon atoms of the carbon atoms included in the 22-membered ring are each terminated by hydrogen. In the structure illustrated in FIG. 4B, two connected six-membered rings are removed from graphene and carbon atoms bonded to the removed six-membered rings are terminated by hydrogen.

In FIG. 4C, graphene includes a vacancy composed of 24 carbon atoms bonded in a ring. Nine carbon atoms of the 24 carbon atoms each have a bond with hydrogen. In FIG. 4C, the 24-membered ring of carbon atoms is illustrated and nine carbon atoms of the carbon atoms included in the 24-membered ring are each terminated by hydrogen. In the structure illustrated in FIG. 4C, three connected six-membered rings are removed from graphene and carbon atoms bonded to the removed six-membered rings are terminated by hydrogen.

In FIG. 5A, graphene includes a vacancy composed of 18 carbon atoms bonded in a ring. Six carbon atoms of the 18 carbon atoms each have a bond with fluorine. In FIG. 5A, the 18-membered ring of carbon atoms is illustrated and six carbon atoms of the carbon atoms included in the 18-membered ring are each terminated by fluorine. In the structure illustrated in FIG. 5A, one six-membered ring is removed from graphene and carbon atoms bonded to the removed six-membered ring are terminated by fluorine.

In FIG. 5B, graphene includes a vacancy composed of 22 carbon atoms bonded in a ring. Eight carbon atoms of the 22 carbon atoms each have a bond with fluorine. In FIG. 5B, the 22-membered ring of carbon atoms is illustrated and eight carbon atoms of the carbon atoms included in the 22-membered ring are each terminated by fluorine. In the structure illustrated in FIG. 5B, two connected six-membered rings are removed from graphene and carbon atoms bonded to the removed six-membered rings are terminated by fluorine.

In FIG. 5C, graphene includes a vacancy composed of 24 carbon atoms bonded in a ring. Nine carbon atoms of the 24 carbon atoms each have a bond with fluorine. In FIG. 5C, the 24-membered ring of carbon atoms is illustrated and nine carbon atoms of the carbon atoms included in the 24-membered ring are each terminated by fluorine. In the structure illustrated in FIG. 5C, three connected six-membered rings are removed from graphene and carbon atoms bonded to the removed six-membered rings are terminated by fluorine. In FIG. 5C, the removed three six-membered rings are connected to each other like phenalene, for example.

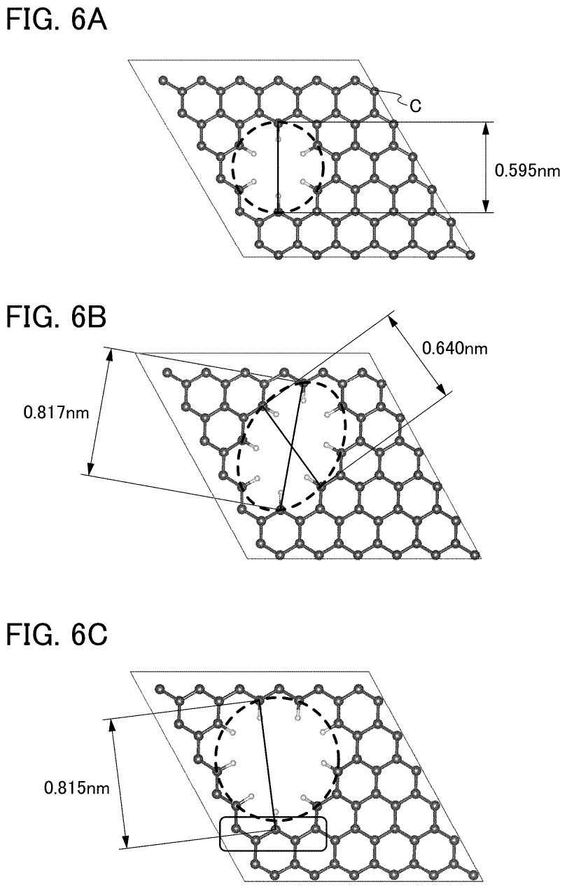

The size of the 18-membered ring included in graphene is described with reference to FIG. 6A. FIG. 6A illustrates a circle including carbon atoms whose distances from the center of the vacancy are short, of the carbon atoms in the 18-membered ring. The diameter of the circle is approximately 0.595 nm. In the structure illustrated in FIG. 6A and the like, a lattice distortion is extremely small; however, in an actual graphene compound, an atomic distance or the like changes due to a distortion in some cases.

Note that the area of the 18-membered ring corresponds to the area of seven six-membered rings. The area of a ring may be converted to the area of a circle and the diameter of the circle may represent the size of the ring, for example. The area of the six-membered ring with an extremely small distortion is approximately 0.0524 nm², for example. The diameter of the circle into which the area of the 18-membered ring is converted is approximately 0.68 nm.

The size of the 18-membered ring included in the graphene is described with reference to FIG. 6B. FIG. 6B illustrates an ellipse including carbon atoms whose distances from the center of the vacancy are short, of the carbon atoms in the 22-membered ring. The major axis and minor axis of the ellipse are approximately 0.817 nm and 0.640 nm, respectively.

Note that the area of the 22-membered ring corresponds to the area of ten six-membered rings. The diameter of the circle into which the area of the 22-membered ring is converted is approximately 0.82 nm.

The size of the 24-membered ring included in graphene is described with reference to FIG. 6C. FIG. 6C illustrates a circle including carbon atoms whose distances from the center of the vacancy are short, of the carbon atoms in the 24-membered ring. Note that the 24-membered ring is further expanded below the circle. In addition, the distance between the carbon atom positioned in the upper portion of the circle and the carbon atom which is close to the center of the vacancy, of five carbon atoms spread below the circle is approximately 0.815 nm.

Note that the area of the 24-membered ring corresponds to the area of twelve six-membered rings. The diameter of the circle into which the area of the 24-membered ring is converted is approximately 0.89 nm.

### <Quantum Mechanics>

A structure optimization is performed with quantum mechanics calculation. A first principle electronic state calculation package, VASP (Vienna ab initio simulation package), is used for the atomic relaxation calculation. As a functional, GGA+U (DFT-D2) is used, and as a pseudopotential, PAW is used. The cut-off energy is set to 600 eV. The k-point grid is 1×1×1.

First, a structure optimization with quantum molecular dynamics calculation is performed on a structure G-1 in which six layers of graphene are layered and the total number of carbon atoms is 432, and a structure G-2 in which four layers of graphene are layered and the total number of carbon atoms is 648. The structure G-2 has a smaller number of graphene layers but a larger area of graphene per unit cell than those of the structure G-1

Then, a vacancy is formed in each of the optimized structures G-1 and G-2. Specifically, one of a 18-membered ring, a 22-membered ring, and a 24-membered ring, which is terminated by hydrogen or fluorine, is formed in one layer in the middle of the layered graphene layers.

Next, one lithium ion is placed at a position [a], a position [b], a position[c], or a position [d], and a structure optimization with quantum molecular dynamics calculation is performed on each structure with a vacancy. The initial value (the position before the calculation) of the position [a] is set below the center of the vacancy and is positioned at the medium height between the adjacent graphene layers. The initial value of the [b] is set above the center of the vacancy and is positioned at the medium height between the adjacent graphene layers. The position [c] is apart from the vacancy as compared with the position [b], and the position [d] is apart from the vacancy as compared with the position [c]. For each position, drawings described below can be referred to.

The energy calculation of the position [a] is performed on both the structure G-1 provided with a vacancy and the structure G-2 provided with a vacancy. The energy calculation of the position [b] is performed on the structure G-1 provided with a vacancy. The energy calculation of the position [c] and the position [d] are performed on the structure G-2 provided with a vacancy.

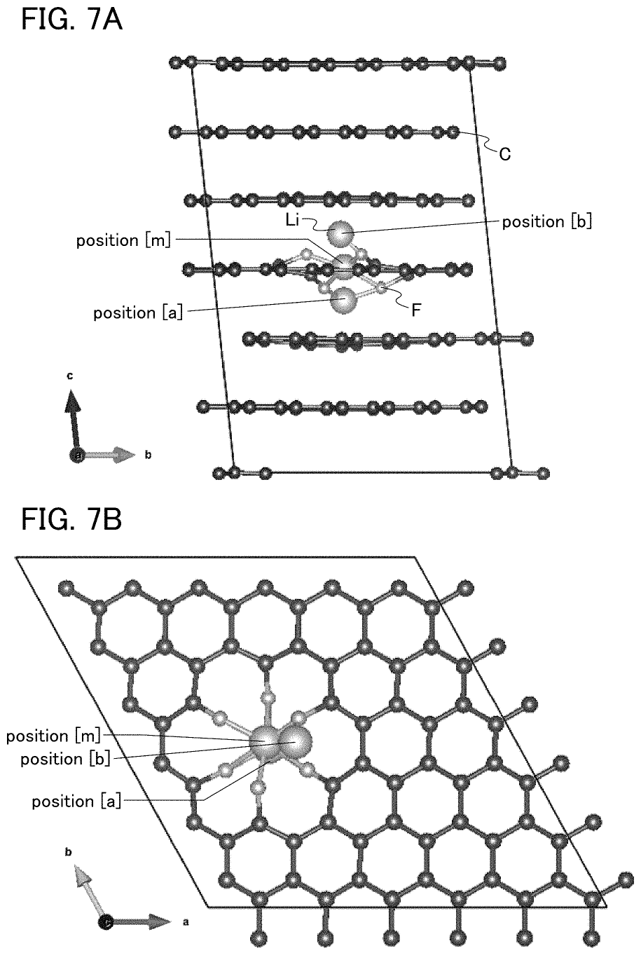

The structures used for the calculation are described with reference to FIG. 7A to FIG. 14. A position [m] illustrated in the drawings is described later.

FIG. 7A illustrates the position [a] and the positon [b] in the structure G-1 in which a 18-membered ring is provided and termination by six fluorine atoms is performed. FIG. 7A is a diagram viewed from the a-axis direction. FIG. 7B is a diagram illustrating the layer provided with a vacancy, viewed from the c-axis direction.

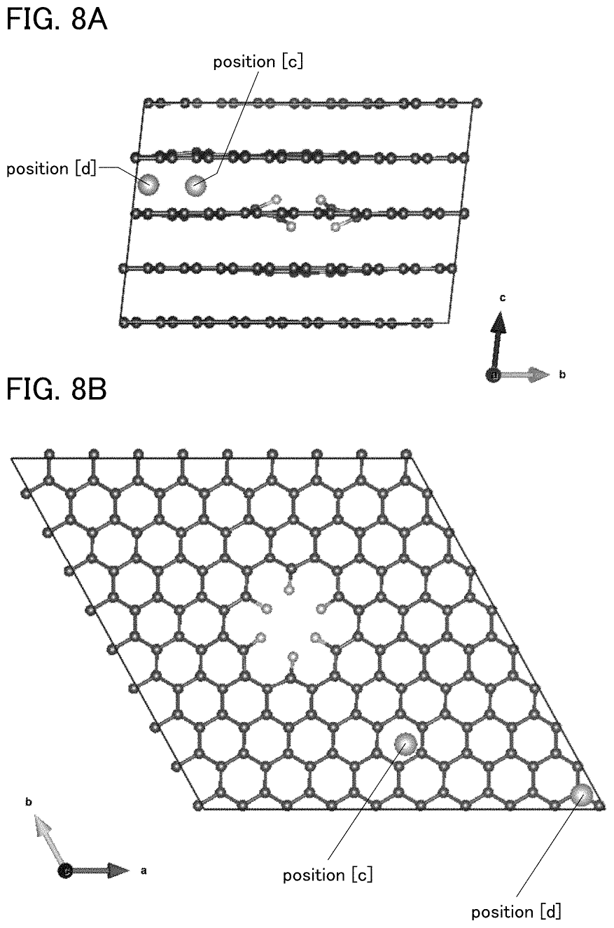

FIG. 8A illustrates the position [c] and the positon [d] in the structure G-2 in which a 18-membered ring is provided and termination by six fluorine atoms is performed. FIG. 8A is a diagram viewed from the a-axis direction. FIG. 8B is a diagram illustrating the layer provided with a vacancy, viewed from the c-axis direction.

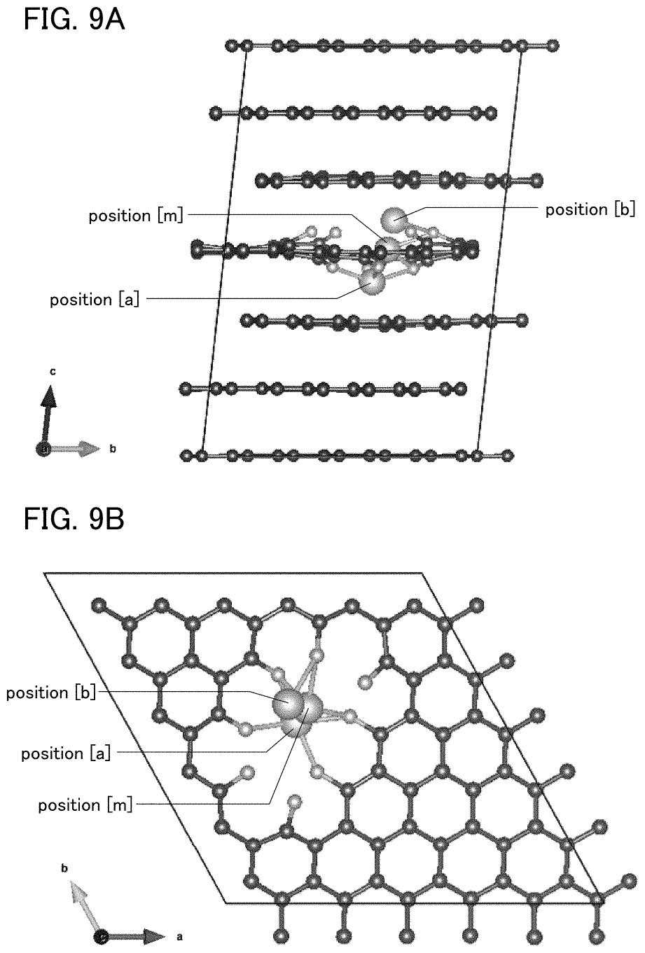

FIG. 9A illustrates the position [a] and the positon [b] in the structure G-1 in which a 22-membered ring is provided and termination by eight fluorine atoms is performed. FIG. 9A is a diagram viewed from the a-axis direction. FIG. 9B is a diagram illustrating the layer provided with a vacancy, viewed from the c-axis direction.

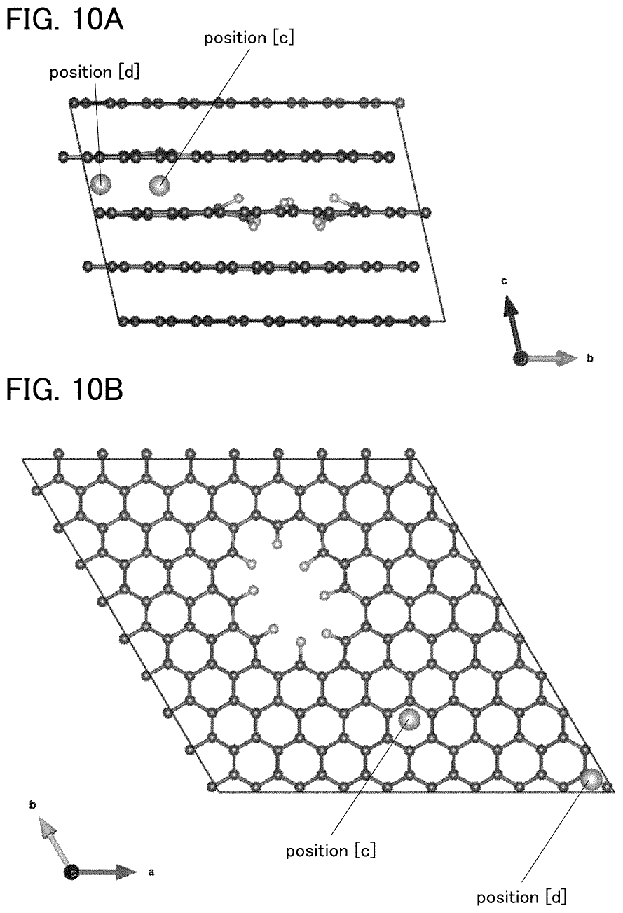

FIG. 10A illustrates the position [c] and the positon [d] in the structure G-2 in which a 22-membered ring is provided and termination by eight fluorine atoms is performed. FIG. 10A is a diagram viewed from the a-axis direction. FIG. 10B is a diagram illustrating the layer provided with a vacancy, viewed from the c-axis direction.

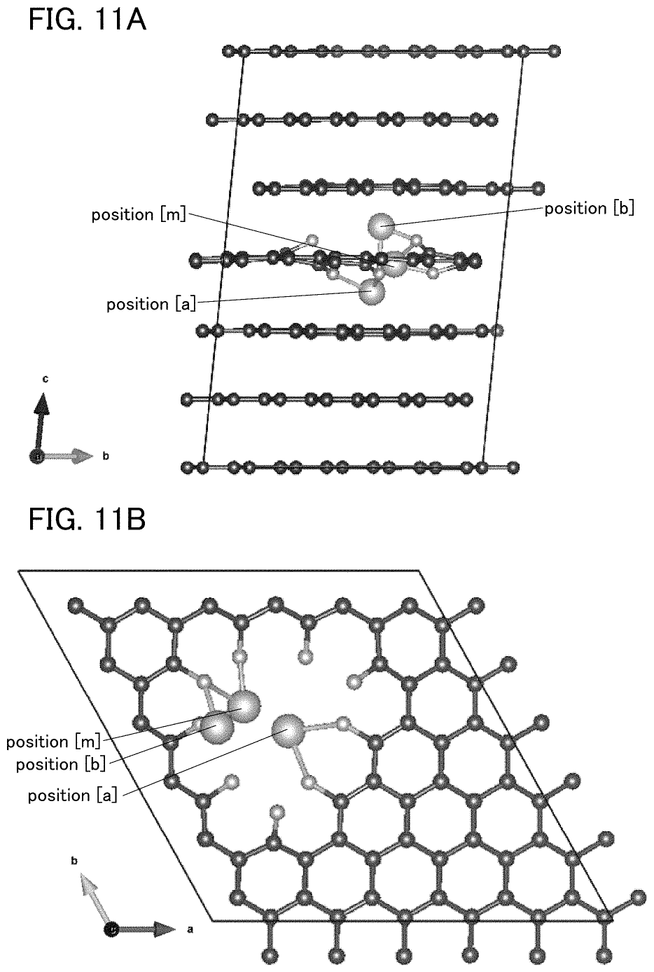

FIG. 11A illustrates the position [a] and the positon [b] in the structure G-1 in which a 24-membered ring is provided and termination by nine fluorine atoms is performed. FIG. 11A is a diagram viewed from the a-axis direction. FIG. 11B is a diagram illustrating the layer provided with a vacancy, viewed from the c-axis direction.

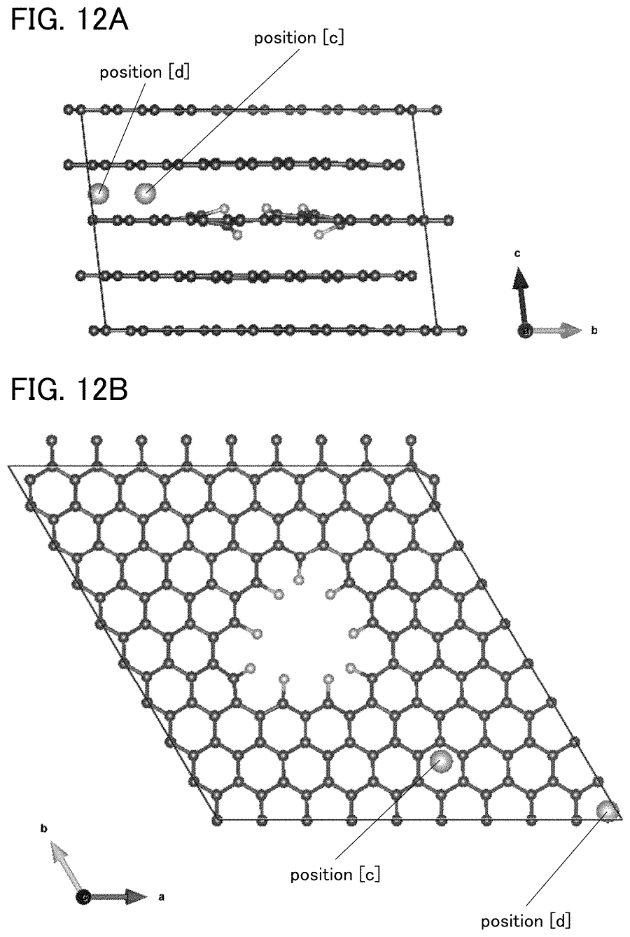

FIG. 12A illustrates the position [c] and the positon [d] in the structure G-2 in which a 24-membered ring is provided and termination by nine fluorine atoms is performed. FIG. 12A is a diagram viewed from the a-axis direction. FIG. 12B is a diagram illustrating the layer provided with a vacancy, viewed from the c-axis direction.

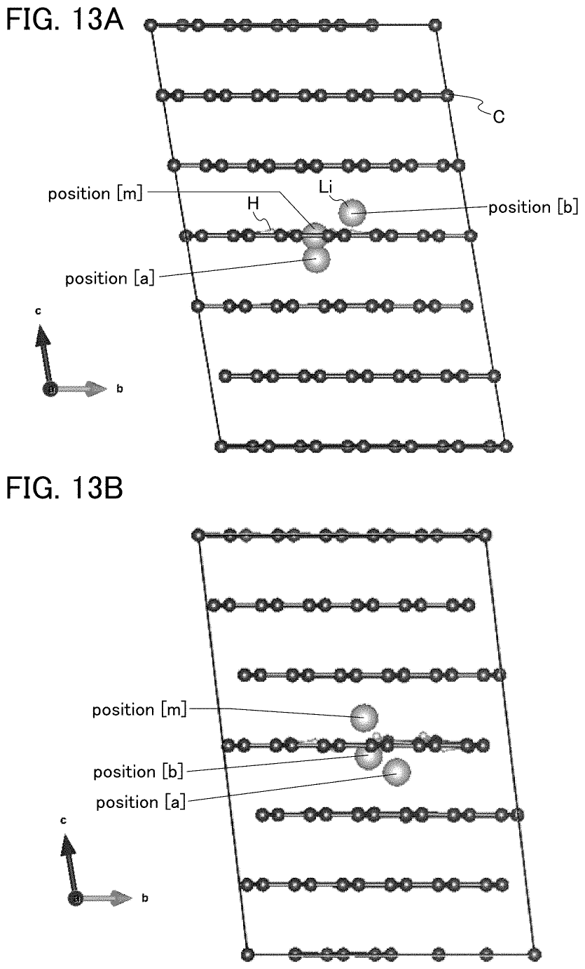

FIG. 13A illustrates the position [a] and the positon [b] in the structure G-1 in which a 18-membered ring is provided and hydrogen termination is performed. FIG. 13A is a diagram viewed from the a-axis direction.

FIG. 13B illustrates the position [a] and the positon [b] in the structure G-1 in which a 22-membered ring is provided and hydrogen termination is performed. FIG. 13B is a diagram viewed from the a-axis direction.

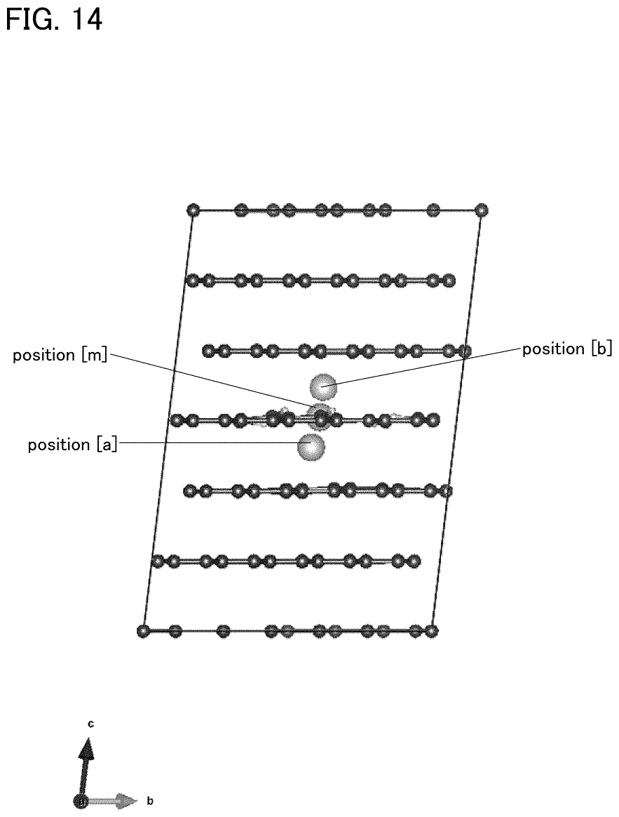

FIG. 14 illustrates the position [a] and the positon [b] in the structure G-1 in which a 24-membered ring is provided and hydrogen termination is performed. FIG. 14 is a diagram viewed from the a-axis direction.

Next, calculation by an NEB (Nudged Elastic Band) method is performed on the path of a lithium ion going from the position [a] to the position [b] through the vacancy and the energy change. Seven points between the initial position [a] and the final position [b] of the path, which have continuous change in coordinates, are formed and the optimization of the positions and energy are performed with use of NEB calculation. Note that the position [m] illustrated in the above-described drawings is the halfway point of the seven points between the position [a] and the position [b] obtained by the NEB method.

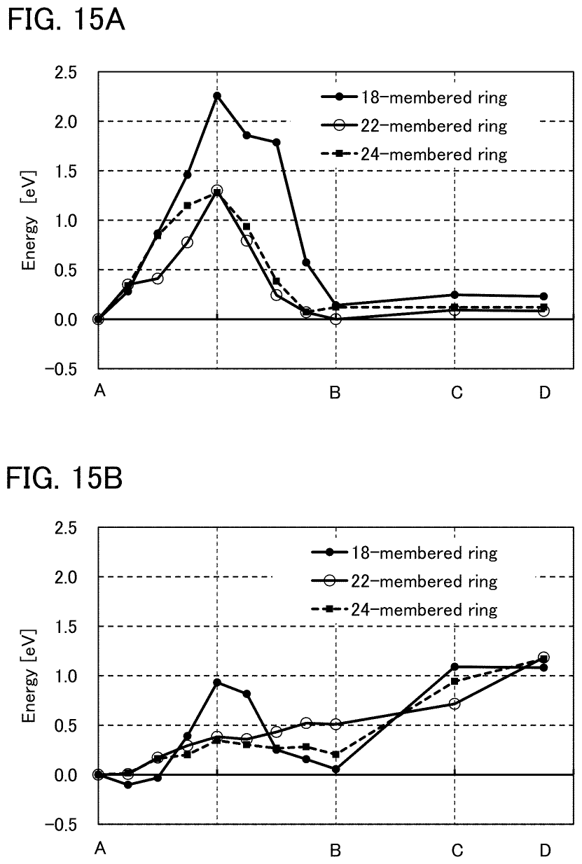

FIG. 15A and FIG. 15B each show results of energy obtained by the NEB method. For the energy of each position, the energy of the position [a] is a reference (0 eV).

FIG. 15A shows a relation between the position of lithium ion and stabilization energy in the layered graphene including the 18-membered ring with hydrogen termination, the layered graphene including the 22-membered ring with hydrogen termination, and the layered graphene including the 24-membered ring with hydrogen termination. FIG. 15B shows a relation between the position of lithium ion and stabilization energy in the layered graphene including the 18-membered ring with termination by six fluorine atoms, the layered graphene including the 22-membered ring with termination by eight fluorine atoms, and the layered graphene including the 24-membered ring with termination by nine fluorine atoms.

It is suggested that energy barriers of 1.0 eV or more are generated in the path from the position [a] to the position [b] and the energy is maximal in the vacancies in the layered graphene including the 18-membered ring with hydrogen termination, the layered graphene including the 22-membered ring with hydrogen termination, and the layered graphene including the 24-membered ring with hydrogen termination. It is also suggested that the energy of the 18-membered ring is higher than those of the 22-membered ring and the 24-membered ring. This is considered to be because the vacancy is small and the distance between the lithium ion and hydrogen is shortened to cause repulsion between atoms.

On the other hand, it is suggested that the energy in the path from the position [a] to the position [b] is lower and a lithium ion more easily passes through a graphene layer in the layered graphene including the 18-membered ring with fluorine termination, the layered graphene including the 22-membered ring with fluorine termination, and the layered graphene including the 24-membered ring with fluorine termination than in those rings with hydrogen termination. The energy of the position [a] and the position [b] located above and below the vacancy is lower than that of the position [c] and the position [d] apart from the vacancy and the entire system tends to be stable. This suggests that the lithium ion tends to stay in the vicinity of the vacancy. This effect is considered to result from the following: fluorine has high electronegativity and is easily charged negatively, and when a positively-charged lithium ion comes close to the negatively-charged fluorine, interaction occurs to allow the stabilization.

It is suggested that a vacancy formed by bonding of a plurality of carbon atoms is formed in graphene and the carbon atoms are terminated by fluorine and thereby a lithium ion can easily pass the vacancy.

### <Calculation 2>

Next, the proportion of fluorine termination is changed in a many-membered ring included in graphene and structure optimization and energy calculation are performed.

As structures for the calculation, a structure in which a 24-membered ring is provided in the above-described structure G-2 and termination by nine hydrogen atoms is performed; a structure in which the 24-membered ring is provided in the above-described structure G-2 and termination by one fluorine atom and eight hydrogen atoms is performed; a structure in which the 24-membered ring is provided in the above-described structure G-2 and termination by two fluorine atoms and seven hydrogen atoms is performed; a structure in which the 24-membered ring is provided in the above-described structure G-2 and termination by three fluorine atoms and six hydrogen atoms is performed; a structure in which the 24-membered ring is provided in the above-described structure G-2 and termination by four fluorine atoms and five hydrogen atoms is performed; a structure in which the 24-membered ring is provided in the above-described structure G-2 and termination by six fluorine atoms and three hydrogen atoms is performed; and, a structure in which the 24-membered ring is provided in the above-described structure G-2 and termination by nine fluorine atoms is performed, are prepared.

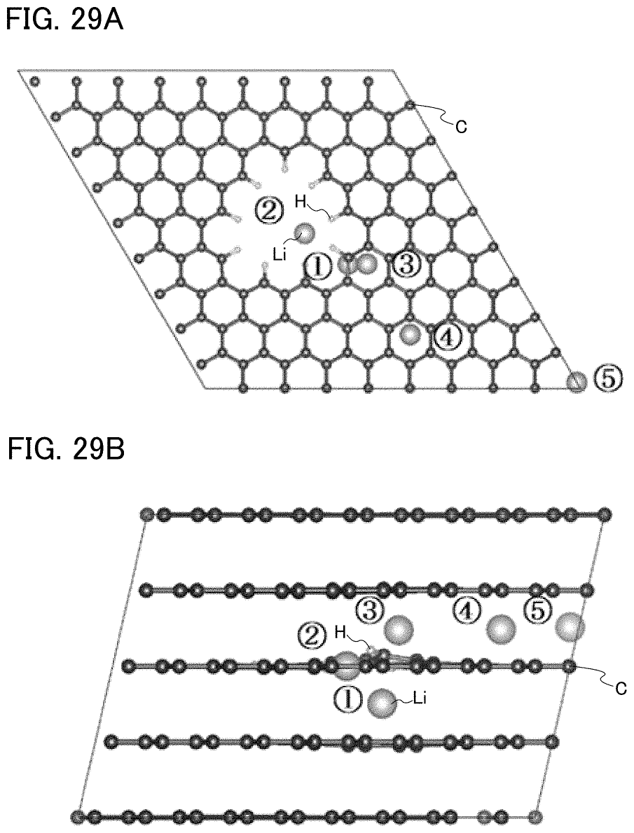

In the prepared structures, lithium ions are placed at five positions (position 1, position 2, position, 3, position 4, and position 5) illustrated in FIG. 29(A) and FIG. 29(B) and structure optimization is performed using quantum molecular dynamics calculation. Note that in drawings, the numbers of 1, 2, 3, 4, and 5 are circled. FIG. 29(A) is a top view of the structure G-2 and FIG. 29(B) is a cross-sectional view of the structure G-2.

FIG. 29(A) and FIG. 29(B) illustrate an example of the structure in which termination by nine hydrogen atoms is performed in the 24-membered ring. Also in the other structures, lithium ions are placed at the same five positions.

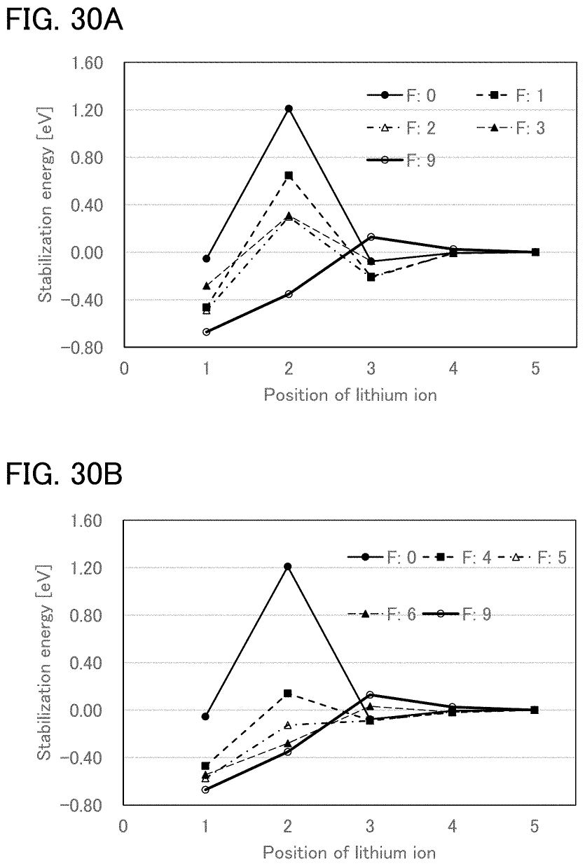

FIGS. 30(A) and 30(B) and Table 1 show energy calculation results of the structures. In FIGS. 30(A) and 30(B), the horizontal axis represents positions of lithium ions and the vertical axis represents stabilization energy.

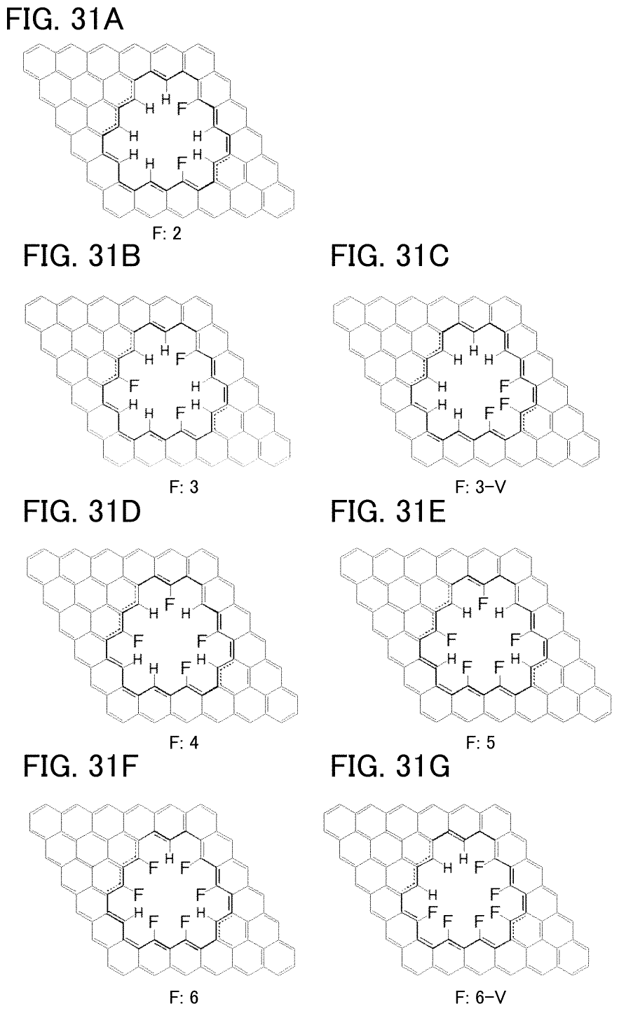

In FIGS. 30(A) and 30(B) and Table 1, the structure with termination by nine hydrogen atoms is represented by F: 0; the structure with termination by one fluorine atom and eight hydrogen atoms is represented by F: 1; the structure with termination by two fluorine atoms and seven hydrogen atoms (see FIG. 31(A)) is represented by F: 2; the structure with termination by three fluorine atoms and six hydrogen atoms, illustrated in FIG. 31(B), is represented by F: 3; the structure in FIG. 31(C) is represented by F:3-V; the structure with termination by four fluorine atoms and five hydrogen atoms (see FIG. 31(D)) is represented by F: 4; the structure with termination by five fluorine atoms and four hydrogen atoms (see FIG. 31(E)) is represented by F: 5; the structure with termination by six fluorine atoms and three hydrogen atoms, illustrated in FIG. 31(F), is represented by F: 6; the structure illustrated in FIG. 31(G) is represented by F: 6-V; and the structure with termination by nine fluorine atoms is represented by F: 9.

TABLE 1
[eV]

| | F: 0 | F: 1 | F: 2 | F: 3 | F: 3-V | F: 4 | F: 5 | F: 6 | F: 6-V | F: 9 |
|---|---|---|---|---|---|---|---|---|---|---|
| 1 | −0.05 | −0.46 | −0.49 | −0.28 | −0.68 | −0.47 | −0.64 | −0.54 | −0.55 | −0.67 |
| 2 | 1.21 | 0.65 | 0.30 | 0.31 | 0.03 | 0.14 | −0.19 | −0.28 | −0.38 | −0.35 |
| 3 | −0.08 | −0.21 | −0.21 | −0.07 | 0.09 | −0.09 | −0.03 | 0.03 | 0.04 | 0.13 |
| 4 | −0.01 | −0.01 | −0.01 | 0.00 | 0.02 | −0.02 | 0.00 | −0.02 | −0.02 | 0.03 |
| 5 | 0.00 | 0.00 | 0.00 | 0.00 | 0.00 | 0.00 | 0.00 | 0.00 | 0.00 | 0.00 |

Table 2 show energy barriers calculated based on the results in Table 1. The energy barrier is a difference between the maximum value and the minimum value in the stabilization energy of the five positions of lithium ions.

TABLE 2
[eV]

| | | | | F: | | | | F: | |
|---|---|---|---|---|---|---|---|---|---|
| F: 0 | F: 1 | F: 2 | F: 3 | 3-V | F: 4 | F: 5 | F: 6 | 6-V | F: 9 |
| 1.29 | 1.11 | 0.79 | 0.59 | 0.76 | 0.61 | 0.64 | 0.58 | 0.59 | 0.80 |

It is suggested that in the case where the 24-membered ring contains no carbon atoms terminated by fluorine, the energy of the position 2 is high and lithium ions have difficulty in passing through the vacancy formed with the 24-membered ring.

Furthermore, it is suggested that when the number of carbon atoms terminated by fluorine in the 24-membered ring is increased to greater than or equal to one and less than or equal to four, the absolute value of the energy of the position 2 is decreased to lower the energy barrier, so that lithium ions can easily pass through the vacancy formed with the 24-membered ring.

Furthermore, because the energy at the position 1 is decreased, the state at the position 1 is probably stabilized due to the interaction between fluorine and lithium. In the structure in which three carbon atoms terminated by fluorine in the 24-membered ring are placed to be close to each other (F:3-V), the energy is the lowest at the position 1.

When the number of carbon atoms terminated by fluorine is five or more, the height of the energy barrier and the energy change at the position 1 are alleviated with an increase in the number of carbon atoms. Moreover, it is suggested that when the number of carbon atoms terminated by fluorine is six or more, the energy at the position 2 has a negative value, the absolute value of the energy is increased, and thus a lithium ion is trapped and has difficulty in passing through the vacancy.

In comparison between the case of four carbon atoms terminated by fluorine and the case of five carbon atoms terminated by fluorine, the energy at the position 2 tends to decrease.

From the above, it can be said that the number of carbon atoms terminated by fluorine is preferably five or less, for example.

In the structure (F:3-V), the change in energy is small at the positions 2, 3, 4, and 5. This shows that it is likely that a lithium ion can most easily pass through the vacancy formed with the 24 membered ring in the structure (F:3-V) of the above-described structures. Thus, it can be said that 33% of the terminal groups included in the 24-membered ring is most preferably terminated by fluorine for the passage of lithium ions through the hole in graphene.

Meanwhile, it is considered to be difficult to control the positions of three carbon atoms terminated by fluorine. There is a high possibility that placement of fluorine termination can be random at end portions of an actual graphene sheet. Therefore, 33% to 67%, inclusive, of the terminal groups included in the 24-membered ring can be terminated by fluorine such that the absolute value of the barrier at the position 2 is approximately 0.3 eV, or preferably, 44% to 56%, inclusive, of the terminal groups included in the 24-membered ring can be terminated by fluorine such that the absolute value of the barrier at the position 2 is approximately 0.2 eV.

### <Example of Negative Electrode Active Material>

In the case where the electrode 570 is a negative electrode, a negative electrode active material can be used as the active material. As a negative electrode active material, a material that can react with carrier ions of a secondary battery, a material that can insert and extract carrier ons, a material that can be alloyed with a metal serving as carrier ions, a material that can dissolve and precipitate a metal serving as carrier ions, or the like is preferably used.

In addition, a metal, a material, or a compound including one or more elements selected from silicon, tin, gallium, aluminum, germanium, lead, antimony, bismuth, silver, zinc, cadmium, and indium, can be used as the negative electrode active material, for example. Examples of an alloy-based material using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

An impurity element such as phosphorus, arsenic, boron, aluminum, or gallium may be added to silicon so that silicon is lowered in resistance.

It is preferable that the negative electrode active material be particles. For example, silicon nanoparticles can be used as the negative electrode active material. The average diameter of a silicon nanoparticle is, for example, preferably greater than or equal to 5 nm and less than 1 μm, more preferably greater than or equal to 10 nm and less than or equal to 300 nm, still more preferably greater than or equal to 10 nm and less than or equal to 100 nm.

The silicon nanoparticles may have crystallinity. The silicon nanoparticles may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle include one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

The analysis of the compound containing silicon can be performed by NMR, XRD, Raman spectroscopy, or the like.

Moreover, carbon-based materials such as graphite, graphitizing carbon, non-graphitizing carbon, a carbon nanotube, carbon black, and a graphene compound can be used as the negative electrode active material, for example.

Furthermore, an oxide including one or more elements selected from titanium, niobium, tungsten, and molybdenum can be used as the negative electrode active material, for example.

A plurality of such a metal, material, compound, and the like described above can be used in combination for the negative electrode active material.

Alternatively, for the negative electrode active material, an oxide such as SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used, for example.

In addition, as the negative electrode active material, Li₃₋ₓMₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g).

A composite nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not cause an alloying reaction with lithium, such as cobalt oxide (CoO), nickel oxide (NiO), and iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

The volume of a negative electrode active material sometimes changes in charging and discharging; however, an electrolyte containing fluorine between a plurality of negative electrode active materials in a negative electrode maintains smoothness and suppresses a crack even when the volume changes in charging and discharging, so that an effect of dramatically increasing cycle performance is obtained. It is important that an organic compound containing fluorine exists between a plurality of active materials included in the negative electrode.

The negative electrode active material of one embodiment of the present invention preferably contains fluorine in a surface portion.

The charge and discharge efficiency of a secondary battery may decrease due to an irreversible reaction typified by a reaction between an electrode and an electrolyte. The charge and discharge efficiency may significantly decrease particularly in the initial charging and discharging.

When the negative electrode active material of one embodiment of the present invention contains halogen in its surface portion, a decrease in charge and discharge efficiency can be suppressed. It is considered that when the negative electrode active material of one embodiment of the present invention contains halogen in its surface portion, a reaction with an electrolyte at the surface of the active material is suppressed. In addition, at least part of the surface of the negative electrode active material of one embodiment of the present invention is covered with a region containing halogen in some cases. The region may have a film shape, for example.

A surface portion is preferably a region that is less than or equal to 50 nm, preferably less than or equal to 35 nm, further preferably less than or equal to 20 nm from the surface, for example. In addition, a region in a deeper position than a surface portion is referred to as an inner portion.

Furthermore, when the negative electrode active material of one embodiment of the present invention contains halogen in its surface portion, there is a possibility that a solvent that solvates a carrier ion in an electrolyte solution is likely to be extracted in the surface of the negative electrode active material. When the solvent that solvates a carrier ion is likely to be extracted, there is a possibility that a secondary battery can exhibit excellent characteristics at high charge and discharge rates. An negative electrode active material in which termination by halogen is performed is preferably used. For example, a material obtained by terminating silicon with halogen such as fluorine can be used as the negative electrode active material.

The negative electrode active material of one embodiment of the present invention preferably contains especially fluorine as halogen. In the case where the negative electrode active material is subjected to measurement by X-ray photoelectron spectroscopy, the concentration of fluorine is preferably higher than or equal to 1 atomic % with respect to the total concentration of fluorine, oxygen, lithium, and carbon.

Fluorine has high electronegativity, and the negative electrode active material containing fluorine in its surface portion may have an effect of facilitating extraction of the solvent that solvates a carrier ion in the surface of the negative electrode active material.

In addition to the negative electrode active material, the conductive agent included in the negative electrode active material layer of one embodiment of the present invention may also be modified with fluorine. For example, a carbon-based material such as a graphene compound, carbon black, graphite, carbon fiber, or fullerene preferably contains fluorine. A carbon-based material containing fluorine can also be referred to as a particulate or fibrous fluorocarbon material. In the case where the carbon-based material is subjected to measurement by X-ray photoelectron spectroscopy, the concentration of fluorine is preferably higher than or equal to 1 atomic % with respect to the total concentration of fluorine, oxygen, lithium, and carbon.

The negative electrode active material and the conductive agent can be modified with fluorine through treatment or heat treatment using a fluorine-containing gas or plasma treatment in a fluorine-containing gas atmosphere, for example. As the fluorine-containing gas, for example, a fluorine gas or a lower hydrofluorocarbon gas such as fluoromethane (CF₄) can be used.

Alternatively, the negative electrode active material and the conductive agent may be modified with fluorine through immersion in a solution containing hydrofluoric acid, tetrafluoroboric acid, hexafluorophosphoric acid, or the like or a solution containing a fluorine-containing ether compound, for example.

Modification of the negative electrode active material and the conductive agent with fluorine is expected to stabilize the structure and suppress a side reaction in charging and discharging process of a secondary battery. The suppression of the side reaction can improve charge and discharge efficiency. In addition, a decrease in capacity caused by repetitive charging and discharging can be suppressed. Thus, when the negative electrode of one embodiment of the present invention includes a negative electrode active material and a conductive agent that are modified with fluorine, an excellent secondary battery can be achieved.

Moreover, in some cases, stabilization of the structures of the negative electrode active material and the conductive agent stabilizes conductive characteristics, leading to high output characteristics.

A fluorine-containing material is stable, and enables stabilization of characteristics, a long lifetime, and the like when used as a component of a secondary battery. Thus, a fluorine-containing material is preferably used for a separator and an exterior body. The details of the separator and the exterior body will be described later.

When the electrode 570 is a positive electrode, a negative electrode active material can be used as the active material. Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

### <Example of Positive Electrode Active Material>

As a positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the positive electrode active material, lithium-manganese composite oxide represented by a composition formula LiₐMn_{b}M_{c}O_{d} can be used. Here, the element M is preferably silicon, phosphorus, or a metal element other than lithium and manganese, further preferably nickel. In the case where the whole particle of a lithium-manganese composite oxide is measured, it is preferable to satisfy the following at the time of discharging: 0<a/(b+c)<2; c>0; and 0.26≤(b+c)/d<0.5. Note that the proportions of metals, silicon, phosphorus, and other elements in the whole particle of a lithium-manganese composite oxide can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. The metal M contains a metal Me1. The metal Me1 is one or more kinds of metals including cobalt. The metal M can further contain a metal X in addition to the metal Me1. The metal X is one or more metals selected from magnesium, calcium, zirconium, lanthanum, barium, copper, potassium, sodium, and zinc.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage is performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

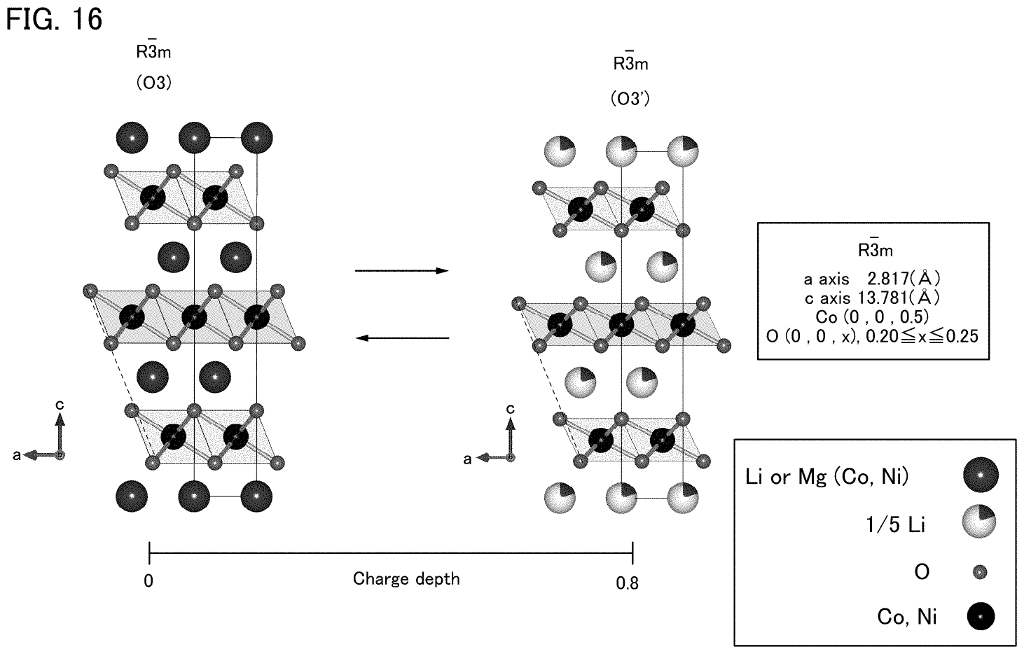

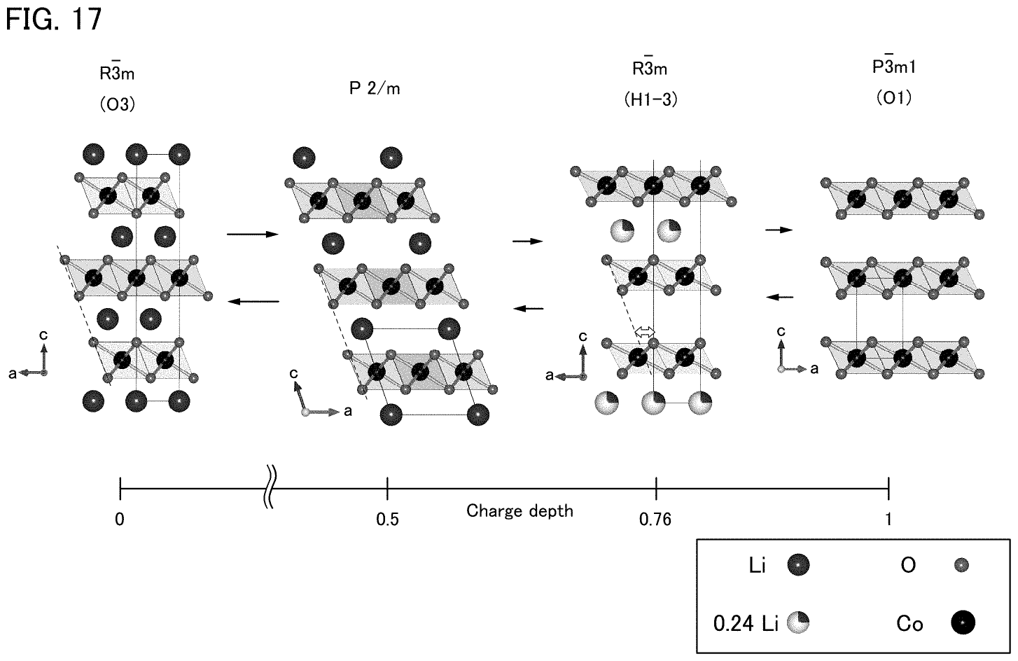

The positive electrode active material is described with reference to FIG. 16 and FIG. 17.

In the positive electrode active material formed according to one embodiment of the present invention, a deviation in the CoO₂ layers can be small in repeated charging and discharging at high voltage. Furthermore, the change in the volume can be small. Thus, the positive electrode active material can have excellent cycle performance. In addition, the positive electrode active material can have a stable crystal structure in a high-voltage charging state. Thus, in the positive electrode active material, a short circuit is less likely to occur while the high-voltage charging state is maintained. This is preferable because the safety is further improved.

The positive electrode active material has a small change in the crystal structure and a small difference in volume per the same number of transition metal atoms between a sufficiently discharging state and a high-voltage charging state.

Preferably, the positive electrode active material is represented by a layered rock-salt crystal structure, and is represented by the space R-3m. The positive electrode active material is a region containing lithium, the metal Me1, oxygen, and the metal X FIG. 16 illustrates examples of the crystal structures of the positive electrode active material before and after charging and discharging. The surface portion of the positive electrode active material may include a crystal containing titanium, magnesium, and oxygen and exhibiting a structure different from a layered rock-salt crystal structure in addition to or instead of the region exhibiting a layered rock-salt crystal structure described below with reference to FIG. 16 and the like. For example, the surface portion of the positive electrode active material may include a crystal containing titanium, magnesium, and oxygen and exhibiting a spinel structure.

The crystal structure with a charge depth of 0 (in the discharged state) in FIG. 16 is R-3m (O3) as in FIG. 17. Meanwhile, the positive electrode active material, illustrated in FIG. 16, with a charge depth in a sufficiently charged state includes a crystal whose structure is different from the H1-3 type crystal structure. This structure belongs to the space group R-3m, and is not a spinel crystal structure but a structure in which an ion of cobalt, magnesium, or the like occupies a site coordinated to six oxygen atoms and the cation arrangement has symmetry similar to that of the spinel structure. Furthermore, the symmetry of CoO₂ layers of this structure is the same as that in the O3 type structure. Accordingly, this structure is referred to as an O3′ type crystal structure or a pseudo-spinel crystal structure in this specification and the like. Note that although lithium exists in any of lithium sites at an approximately 20% probability in the diagram of the O3′ type crystal structure illustrated in FIG. 16, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine may exist in oxygen sites at random.

Note that in the O3′ type crystal structure, a light element such as lithium is sometimes coordinated to four oxygen atoms. Also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type structure is close to a crystal structure of lithium nickel oxide when charged up to a charge depth of 0.94 (Li_{0.06}NiO₂); however, pure lithium cobalt oxide or a layered rock-salt positive electrode active material including a large amount of cobalt is known not to have this crystal structure generally.

Anions of a layered rock-salt crystal and anions of a rock-salt crystal have a cubic close-packed structure (face-centered cubic lattice structure). Anions of an O3′ type crystal are also presumed to form a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

In the positive electrode active material illustrated in FIG. 16, a change in the crystal structure when the positive electrode active material is charged with high voltage and a large amount of lithium is extracted is inhibited as compared with a comparative example described later. As shown by dotted lines in FIG. 16, for example, CoO₂ layers hardly deviate in these crystal structures.

More specifically, the structure of the positive electrode active material illustrated in FIG. 16 is highly stable even when a charge voltage is high. For example, in FIG. 17, an H1-3 type crystal structure is formed at a voltage of approximately 4.6 V, which is a charge voltage causing a H1-3 crystal structure, with the potential of e.g., a lithium metal as the reference; however, the positive electrode active material of one embodiment of the present invention can maintain the crystal structure of R-3m (O3) even at the charging voltage of approximately 4.6 V. Even at higher charge voltages, e.g., a voltage of approximately 4.65 V to 4.7 V with the potential of a lithium metal as the reference, the positive electrode active material of one embodiment of the present invention can have a region of the O3′ type crystal structure. At a charge voltage increased to be higher than 4.7 V, an H1-3 type crystal may be finally observed in the positive electrode active material of one embodiment of the present invention. In addition, the positive electrode active material of one embodiment of the present invention might have the O3′ type crystal structure even at a lower charge voltage (e.g., a charge voltage of greater than or equal to 4.5 V and less than 4.6 V with the potential of a lithium metal as the reference). Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with the potential of a lithium metal as the reference. Thus, even in a secondary battery that includes graphite as a negative electrode active material and has a voltage of greater than or equal to 4.3 V and less than or equal to 4.5 V, for example, the positive electrode active material of one embodiment of the present invention can maintain the crystal structure of R-3m (O3) and moreover, includes a region that can have the O3′ type crystal structure at higher voltages, e.g., a voltage of the secondary battery greater than 4.5 V and less than or equal to 4.6 V. In addition, the positive electrode active material of one embodiment of the present invention can have the O3′ type crystal structure at lower charge voltages, e.g., at a voltage of the secondary battery of greater than or equal to 4.2 V and less than 4.3 V, in some cases.

Thus, in the positive electrode active material illustrated in FIG. 16, the crystal structure is less likely to be disordered even when charging and discharging are repeated at high voltage.

In addition, in the positive electrode active material of one embodiment of the present invention, a difference in the volume per unit cell between the O3 type crystal structure with a charge depth of 0 and the O3′ type crystal structure with a charge depth of 0.8 is less than or equal to 2.5%, specifically, less than or equal to 2.2%.

In the unit cell of the O3′ type crystal structure, the coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high; thus, magnesium is highly likely to enter the cobalt sites. Magnesium in the cobalt sites is less effective in maintaining the R-3m structure in high-voltage charging in some cases. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium over a whole particle. The addition of the halogen compound depresses the melting point of lithium cobalt oxide. The decreased melting point makes it easier to distribute magnesium throughout the particle at a temperature at which the cation mixing is unlikely to occur. Furthermore, it is expected that the existence of the fluorine compound can improve corrosion resistance to hydrofluoric acid generated by decomposition of an electrolyte.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material formed according to one embodiment of the present invention is preferably 0.001 times or more and 0.1 times or less, further preferably more than 0.01 times and less than 0.04 times, still further preferably approximately 0.02 times as large as the number of cobalt atoms. The magnesium concentration described here may be a value obtained by element analysis on overall particles of the positive electrode active material using ICP-MS or the like, or may be a value based on the ratio of the raw materials mixed in the process of forming the positive electrode active material, for example.

The number of nickel atoms in the positive electrode active material is preferably 7.5% or lower, preferably 0.05% or higher and 4% or lower, further preferably 0.1% or higher and 2% or lower of the number of cobalt atoms. The nickel concentration described here may be a value obtained by element analysis on overall particles of the positive electrode active material using ICP-MS or the like, or may be a value based on the ratio of the raw materials mixed in the forming process of the positive electrode active material, for example.

### <Particle Diameter>

A too large particle diameter of the positive electrode active material causes problems such as difficulty in lithium diffusion and too much surface roughness of an active material layer in coating to a current collector. By contrast, too small a particle diameter causes problems such as difficulty in loading of the active material layer at the time when the material is applied to the current collector and overreaction with the electrolyte. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the positive electrode active material has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charging and discharging. In addition, it should be noted that an objective crystal structure is not obtained in some cases only by addition of impurity elements. For example, in a high-voltage charged state, lithium cobalt oxide containing magnesium and fluorine has the O3′ type structure at 60 wt % or more in some cases, and has the H1-3 type structure at 50 wt % or more in other cases. Furthermore, at a predetermined voltage, the positive electrode active material has almost 100 wt % of the O3′ type crystal structure, and with an increase in the predetermined voltage, the H1-3 type crystal structure is generated in some cases. Thus, the crystal structure of the positive electrode active material 811 is preferably analyzed by XRD or the like. The combination with XRD measurement or the like enables more detailed analysis.

Note that a positive electrode active material in the high-voltage charged state or the discharged state sometimes causes a change in the crystal structure when exposed to air. For example, the O3′ type crystal structure changes into the H1-3 type crystal structure in some cases. Thus, all samples are preferably handled in an inert atmosphere such as an atmosphere containing argon.

A positive electrode active material illustrated in FIG. 17 is lithium cobalt oxide (LiCoO₂) to which the metal X is not added. The crystal structure of the lithium cobalt oxide illustrated in FIG. 17 is changed depending on a charge depth.

As illustrated in FIG. 17, lithium cobalt oxide with a charge depth of 0 (the discharged state) includes a region having the crystal structure of the space group R-3m, and includes three CoO₂ layers in a unit cell. Thus, this crystal structure is referred to as an O3 type crystal structure in some cases. Note that, the CoO₂ layer has a structure in which an octahedral structure with cobalt coordinated to six oxygen atoms continues on a plane in an edge-sharing state.

Lithium cobalt oxide with a charge depth of 1 has the crystal structure belonging to the space group P-3m1 and includes one CoO₂ layer in a unit cell. Hence, this crystal structure is referred to as an 01 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 17, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the O3′ type crystal structure of one embodiment of the present invention is preferably represented by a unit cell containing one cobalt and one oxygen. This means that the symmetry of cobalt and oxygen differs between the O3′ type crystal structure and the H1-3 type structure, and the amount of change from the O₃ structure is smaller in the O3′ type crystal structure than in the H1-3 type structure. A preferred unit cell for representing a crystal structure in a positive electrode active material can be selected such that the value of GOF (goodness of fit) is smaller in Rietveld analysis of XRD, for example.

When charge with a high voltage of 4.6 V or higher based on the redox potential of a lithium metal or charge with a large charge depth of 0.8 or more and discharge are repeated, a change of the crystal structure of lithium cobalt oxide between the H1-3 type crystal structure and the R-3m (O3) structure in a discharged state (i.e., an unbalanced phase change) occurs repeatedly

However, there is a large deviation in the CoO₂ layer between these two crystal structures. As indicated by dotted lines and an arrow in FIG. 17, the CoO₂ layer in the H1-3 type crystal structure greatly deviates from that in the R-3m (O3) structure. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3m1 (O1), included in the H1-3 type crystal structure is highly likely to be unstable.

Thus, the repeated high-voltage charging and discharging breaks the crystal structure of lithium cobalt oxide. The break of the crystal structure degrades the cycle performance. This is probably because the break of the crystal structure reduces sites where lithium can stably exist and makes it difficult to insert and extract lithium.

### <Electrolyte>

In the case of using a liquid electrolyte for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte, for example.

Alternatively, the use of one or more ionic liquids (room temperature molten salts) that are incombustible and hard to volatile as the solvent of the electrolyte can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention may include as a carrier ion one or more selected from alkali metal ions such as a sodium ion and a potassium ion and alkaline earth metal ions such as a calcium ion, a strontium ion, a barium ion, a beryllium ion, and a magnesium ion.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂, or the like can be used, for example.

In addition, the electrolyte preferably contains fluorine. As the electrolyte containing fluorine, an electrolyte including one kind or two or more kinds of fluorinated cyclic carbonates and lithium ions can be used, for example. The fluorinated cyclic carbonate can improve the nonflammability of the electrolyte and improve the safety of the lithium-ion secondary battery.

As the fluorinated cyclic carbonate, an ethylene fluoride carbonate such as monofluoroethylene carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, it is important that a lithium ion is solvated by using one kind or two or more kinds of fluorinated cyclic carbonates as the electrolyte and is transported in the electrolyte included in the electrode in charging and discharging. When the fluorinated cyclic carbonate is not used as a small amount of additive but is allowed to contribute to transportation of a lithium ion in charging and discharging, operation can be performed at low temperatures. In the secondary battery, a cluster of approximately several to several tens of lithium ions moves.

The use of the fluorinated cyclic carbonate for the electrolyte can reduce desolvation energy that is necessary for the solvated lithium ion in the electrolyte of the electrode to enter an active material particle. The reduction in the desolvation energy facilitates insertion of a lithium ion into the active material or extraction of the lithium ion from the negative electrode active material particle even in a low-temperature range. Although a lithium ion sometimes moves remaining in the solvated state, a hopping phenomenon in which coordinated solvent molecules are interchanged occurs in some cases. When desolvation of the solvent from a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Therefore, the deterioration of the secondary battery can be suppressed.

In some cases, a plurality of solvated lithium ions form a cluster in the electrolyte and the cluster moves in the negative electrode, between the positive electrode and the negative electrode, or in the positive electrode, for example.

An example of the fluorinated cyclic carbonate is shown below.

The monofluoroethylene carbonate (FEC) is represented by Formula (1) below.

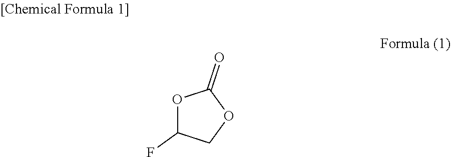

The tetrafluoroethylene carbonate (F4EC) is represented by Formula (2) below.

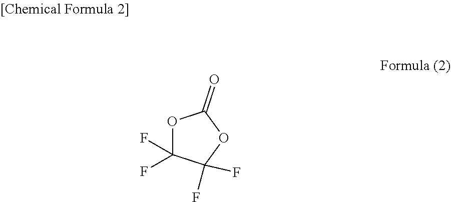

The difluoroethylene carbonate (DFEC) is represented by Formula (3) below.

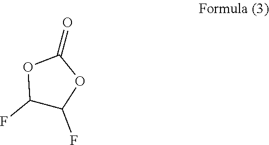

In this specification, an electrolyte is a general term of a solid material, a liquid material, a semi-solid-state material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly as compared with FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. The electrolyte containing fluorine that solvates lithium reduces generation of a decomposition product that is to be attached to the surface of the active material (the positive electrode active material or the negative electrode active material). Moreover, the use of the electrolyte containing fluorine can prevent attachment of a decomposition product, which can prevent generation and growth of a dendrite.

The use of the electrolyte containing fluorine as a main component is also a feature, and the amount of the electrolyte containing fluorine is higher than or equal to 5 volume %, or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

Furthermore, an additive agent such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more of aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the polymer material, for example, one or more selected from a polymer having a polyalkylene oxide structure, such as polyethylene oxide (PEO); PVDF; polyacrylonitrile; and a copolymer containing any of them can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the negative electrode of one embodiment of the present invention is a secondary battery having high charge and discharge capacity. The semi-solid-state battery can have high charge and discharge voltages. In addition, a highly safe or reliable semi-solid-state battery can be provided.

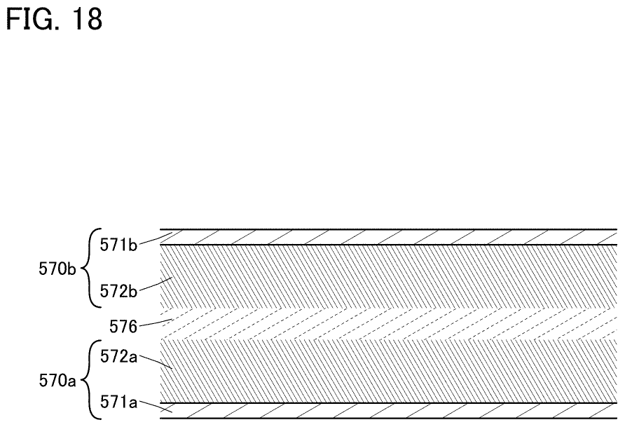

Here, an example in which a semi-solid-state battery is fabricated will be described with reference to FIG. 18.

FIG. 18 is a schematic cross-sectional view of a secondary battery of one embodiment of the present invention. The secondary battery of one embodiment of the present invention includes the negative electrode 570a and the positive electrode 570b. The negative electrode 570a includes at least the negative electrode current collector 571a and the negative electrode active material layer 572a formed in contact with the negative electrode current collector 571a, and the positive electrode 570b includes at least the positive electrode current collector 571b and the positive electrode active material layer 572b formed in contact with the positive electrode current collector 571b. The secondary battery includes the electrolyte 576 between the negative electrode 570a and the positive electrode 570b.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions melt to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590 Å in the case of tetracoordination, 0.76 Å in the case of hexacoordination, and 0.92 Å in the case of octacoordination. The radius of a bivalent oxygen ion is 1.35 Å in the case of bicoordination, 1.36 Å in the case of tricoordination, 1.38 Å in the case of tetracorrdination, 1.40 Å in the case of hexacoordination, and 1.42 Å in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably a distance that causes sufficient interaction between the lithium ions and the polar groups. Note that the distance is not necessarily always kept constant because the segmental motion occurs as described above. It is acceptable to obtain an appropriate distance for the passage of lithium ions.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithiumbis(fluorosulfonyl)amide, LiFSA), LiClO₄, LiAsF₆, LiBF₄, LiAlCl₄, LiSCN, LiBr, LiI, Li₂SO₄, Li₂BioCl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂ (lithiumbis(trifluoromethanesulfonyl)amide, LiTFSA), LiN(C₄F₉SO₂)(CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSA because favorable characteristics at low temperatures can be obtained. Note that LiFSA and LiTFSA are less likely to react with water than LiPF₆ or the like. This can relax the dew point control in fabricating an electrode and an electrolyte layer that use LiFSA. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSA and LiTFSA, in which case the operating temperature range can be wide.

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or an ethylene-propylene-diene polymer.

Since the lithium-ion conductive polymer is a high molecular compound, the active material and the conductive material can be bound onto the current collector when the lithium-ion conductive polymer is sufficiently mixed in the active material layer. Thus, the electrode can be fabricated without a binder. A binder is a material that does not contribute to charge and discharge reactions. Thus, a smaller number of binders enable higher proportion of materials that contribute to charging and discharging, such as an active material and an electrolyte. As a result, the secondary battery can have higher discharge capacity, improved cycle performance, or the like.

When containing no or extremely little organic solvent, the secondary battery can be less likely to catch fire and ignite and thus can have higher level of safety, which is preferable. When the electrolyte 576 is an electrolyte layer containing no or extremely little organic solvent, the electrolyte layer can have enough strength and thus can electrically insulate the positive electrode from the negative electrode without a separator. Since a separator is not necessary, the secondary battery can have high productivity. When the electrolyte 576 is an electrolyte layer containing an inorganic filler, the secondary battery can have higher strength and higher level of safety.

Drying is sufficiently performed so that the electrolyte 576 can be an electrolyte layer containing no or extremely little organic solvent. In this specification and the like, the electrolyte layer can be regarded as being dried sufficiently when a change in the weight after drying at 90° C. under reduced pressure for one hour is within 5%.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the active material layer is subjected to suspension using a solvent to separate the active material from the other materials.

In addition, in each of the above structures, a solid electrolyte material may be further contained in the negative electrode to increase incombustibility. As the solid electrolyte material, an oxide-based solid electrolyte is preferably used.

Examples of the oxide-based solid electrolyte are lithium composite oxides and lithium oxide materials such as LiPON, Li₂O, Li₂CO₃, Li₂MoO₄, Li₃PO₄, Li₃VO₄, Li₄SiO₄, LLT(La_{2/3-x}Li₃ₓTiO₃), and LLZ(Li₇La₃Zr₂O₁₂).

LLZ is a garnet-type oxide containing Li, La, and Zr and may be a compound containing Al, Ga, or Ta.

Alternatively, a polymer solid electrolyte such as PEO (polyethylene oxide) formed by a coating method or the like may be used. Such a polymer solid electrolyte can also function as a binder; thus, in the case of using a polymer solid electrolyte, the number of components of the electrode can be reduced and the manufacturing cost can also be reduced.

This embodiment can be implemented in appropriate combination with any of the other embodiments.

### Embodiment 2

In this embodiment, examples of a secondary battery of one embodiment of the present invention are described.

### Structure Example 1 of Secondary Battery

Hereinafter, a secondary battery in which a positive electrode, a negative electrode, and an electrolyte solution are wrapped in an exterior body is described as an example.

### [Negative Electrode]

The negative electrode described in the above embodiment can be used as the negative electrode.

### [Current Collector]

For each of a positive electrode current collector and a negative electrode current collector, it is possible to use a material which has high conductivity and is not alloyed with carrier ions such as lithium, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions such as lithium is preferably used for the negative electrode current collector.

As the current collector, a titanium compound may be stacked over the above-described metal element. As a titanium compound, for example, it is possible to use one selected from titanium nitride, titanium oxide, titanium nitride in which part of nitrogen is substituted by oxygen, titanium oxide in which part of oxygen is substituted by nitrogen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

### [Positive Electrode]

The positive electrode includes a positive electrode active material layer and the positive electrode current collector. The positive electrode active material layer includes a positive electrode active material, and may include a conductive material and a binder. As the positive electrode active material, the positive electrode active material formed by the formation method described in the above embodiments is used.

For the conductive material and the binder that can be included in the positive electrode active material layer, materials similar to those of the conductive material and the binder that can be included in the negative electrode active material layer can be used.

### [Separator]

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator is a porous material having a hole with a size of approximately 20 nm, preferably a hole with a size of greater than or equal to 6.5 nm, further preferably a hole with a diameter of at least 2 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be inhibited and thus the reliability of the secondary battery can be improved. When the separator is coated with the fluorine-based material, the separator is easily in close contact with an electrode, resulting in high output characteristics. When the separator is coated with the polyamide-based material, especially, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, one or more selected from metal materials such as aluminum and resin materials can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be implemented in appropriate combination with any of the other embodiments.

### Embodiment 3

This embodiment will describe examples of shapes of several types of secondary batteries including a positive electrode or a negative electrode formed by the manufacturing method described in the foregoing embodiment.

### [Coin-Type Secondary Battery]

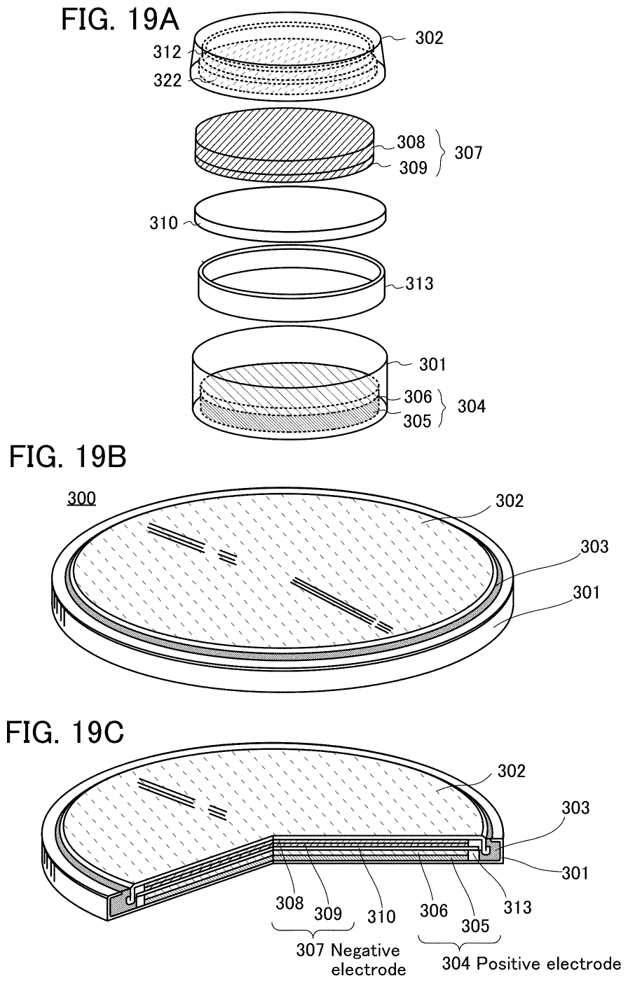

An example of a coin-type secondary battery is described. FIG. 19A is an exploded perspective view of a coin-type (single-layer flat type) secondary battery, FIG. 19B is a perspective view of the appearance, and FIG. 19C is a cross-sectional perspective view thereof. Coin-type secondary batteries are mainly used in small electronic devices.

For easy understanding, FIG. 19A is a schematic view illustrating overlap (a vertical relation and a positional relation) between components. Thus, FIG. 19A and FIG. 19B do not completely correspond with each other.

In FIG. 19A, a positive electrode 304, a separator 310, a negative electrode 307, a spacer 322, and a washer 312 are overlaid. These components are sealed with a negative electrode can 302 and a positive electrode can 301. Note that a gasket for sealing is not illustrated in FIG. 19A. The spacer 322 and the washer 312 are used to protect the inside or fix the position inside the cans at the time when the positive electrode can 301 and the negative electrode can 302 are bonded with pressure. For each of the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 19B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 may be provided with an active material layer.

For the positive electrode can 301 and the negative electrode can 302, a material having corrosion resistance to an electrolyte can be used. For example, a metal such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 19C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity and excellent cycle performance. Note that in the case of a secondary battery, the separator 310 is not necessarily provided between the negative electrode 307 and the positive electrode 304.

### [Cylindrical Secondary Battery]

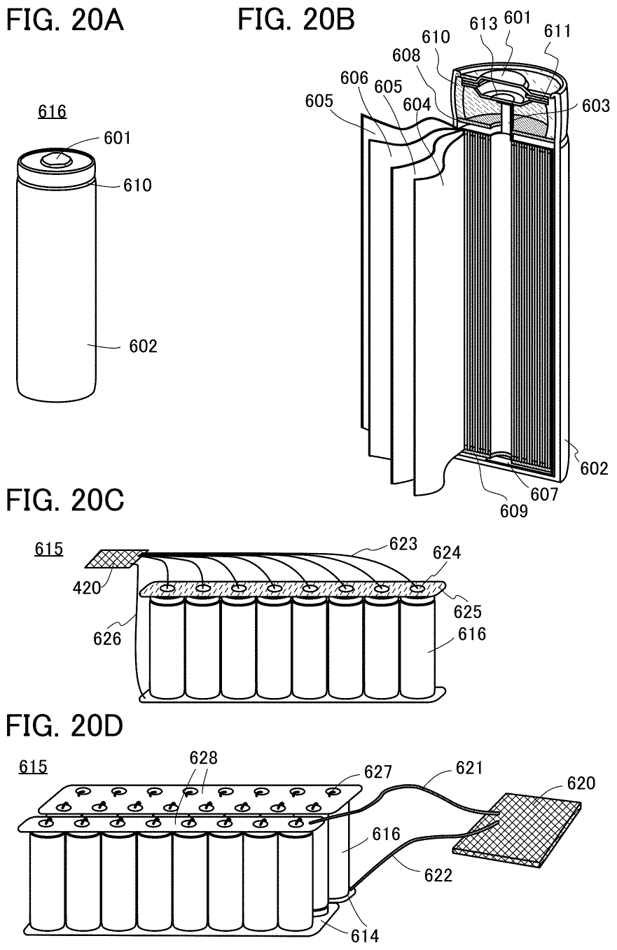

An example of a cylindrical secondary battery is described with reference to FIG. 20A. As illustrated in FIG. 20A, a cylindrical secondary battery 616 includes a positive electrode cap (battery cap) 601 on the top surface and a battery can (outer can) 602 on the side surface and bottom surface. The battery can (outer can) 602 is formed of a metal material and has an excellent barrier property against water permeation and an excellent gas barrier property. The positive electrode cap 601 and the battery can (outer can) 602 are insulated from each other by a gasket (insulating gasket) 610.

FIG. 20B schematically illustrates a cross section of a cylindrical secondary battery. The cylindrical secondary battery illustrated in FIG. 20B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a material having corrosion resistance to an electrolyte can be used. For example, a metal such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The negative electrode obtained in Embodiment 1 is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. For both the positive electrode terminal 603 and the negative electrode terminal 607, metal materials such as aluminum can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 20C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging or overdischarging can be used. The control circuit 620 has a function of performing one or more of controlling charging, controlling discharging, measuring charge voltage, measuring discharge voltage, measuring charge current, measuring discharge current, and measuring remaining capacity by accumulation of charge amount, for example. Moreover, the control circuit 620 has a function of performing one or more of detecting overcharging, detecting overdischarging, detecting charge overcurrent, and detecting discharge overcurrent, for example. The control circuit 620 preferably has a function of performing one or more of stopping charging, stopping discharging, changing a charging condition, and changing a discharging condition, on the basis of the results of the above-described detection.

FIG. 20D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in parallel and then be further connected in series.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 20D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Structure Examples of Secondary Battery]

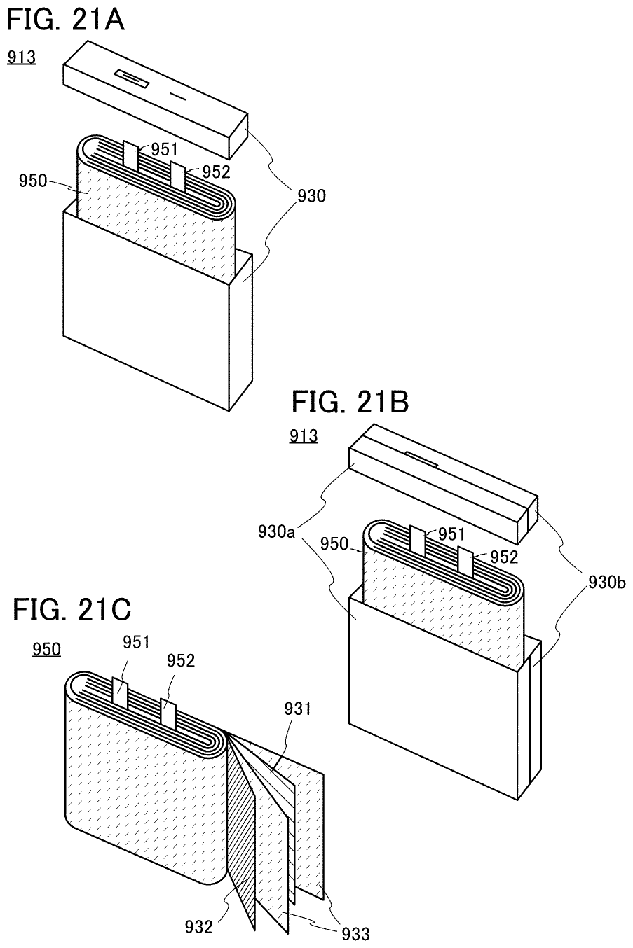

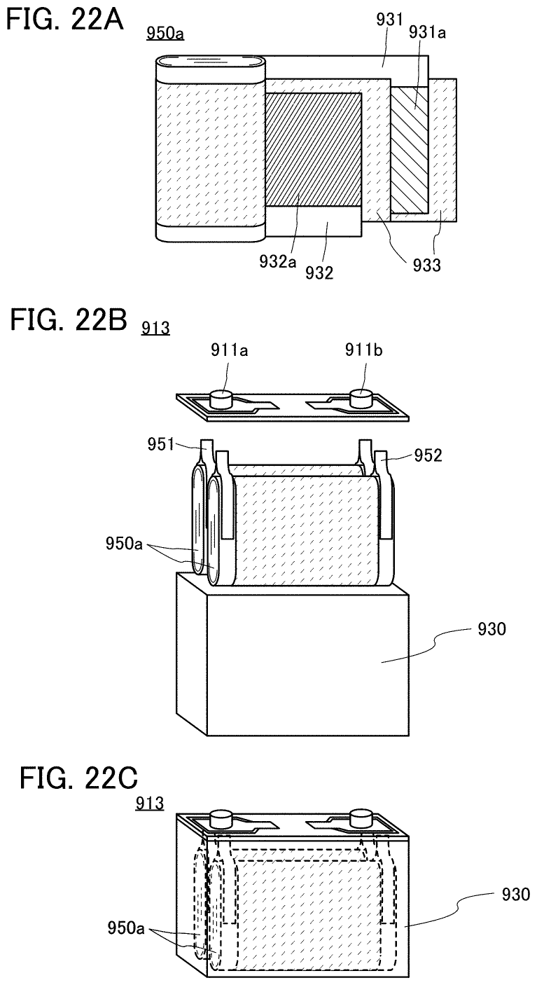

Structure examples of secondary batteries are described with reference to FIG. 21 and FIG. 22.

A secondary battery 913 illustrated in FIG. 21A includes a wound body 950 provided with a terminal 951 and a terminal 952 inside a housing 930. The wound body 950 is immersed in an electrolyte inside the housing 930. The terminal 952 is in contact with the housing 930. The terminal 951 is not in contact with the housing 930 with use of an insulator or the like. Note that in FIG. 21A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 21B, the housing 930 in FIG. 21A may be formed using a plurality of materials. For example, in the secondary battery 913 illustrated in FIG. 21B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 21C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 22, the secondary battery 913 may include a wound body 950a. The wound body 950a illustrated in FIG. 22A includes the negative electrode 931, the positive electrode 932, and the separators 933. The negative electrode 931 includes a negative electrode active material layer 931a. The positive electrode 932 includes a positive electrode active material layer 932a.

The negative electrode structure obtained in Embodiment 1, i.e., an electrolyte containing fluorine is used for the negative electrode 931, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 22A and FIG. 22B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 22C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 22B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 21A to FIG. 21C can be referred to for the other components of the secondary battery 913 illustrated in FIG. 22A and FIG. 22B.

### <Laminated Secondary Battery>

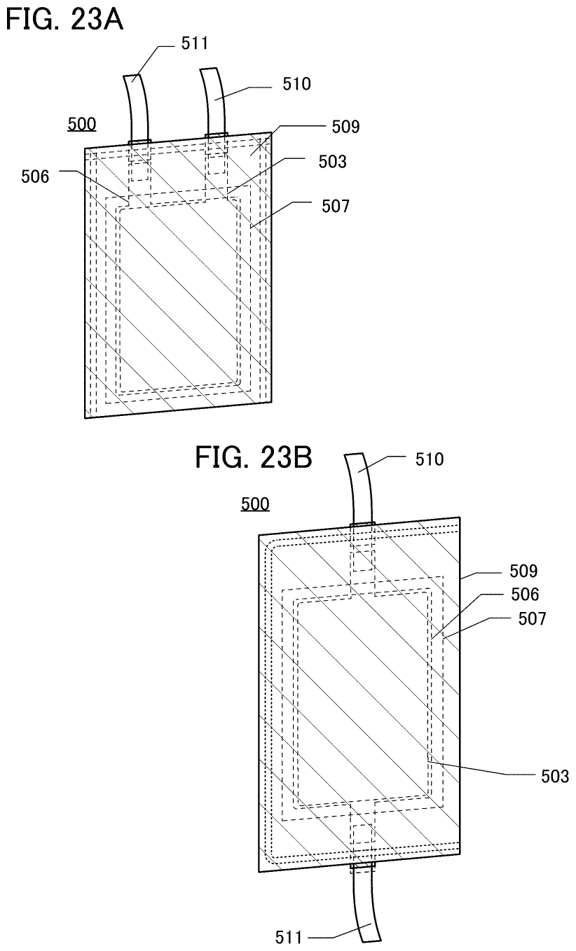

Next, examples of the appearance of a laminated secondary battery are illustrated in FIG. 23A and FIG. 23B. FIG. 23A and FIG. 23B each include a positive electrode 503, a negative electrode 506, a separator 507, an exterior body 509, a positive electrode lead electrode 510, and a negative electrode lead electrode 511.

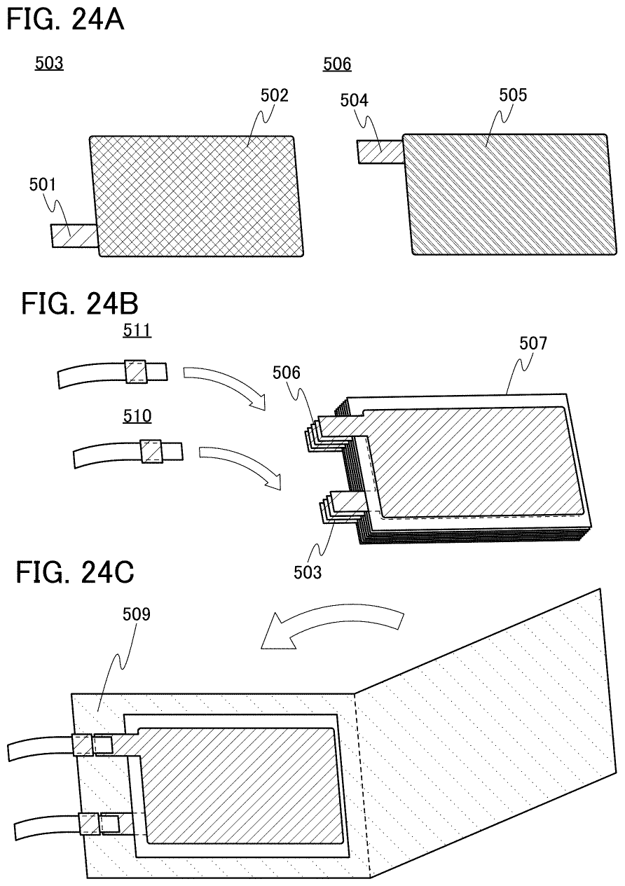

FIG. 24A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 24A.

### <Method for Manufacturing Laminated Secondary Battery>

Here, an example of a method for manufacturing the laminated secondary battery whose external view is illustrated in FIG. 23A will be described with reference to FIG. 24B and FIG. 24C.

First, the negative electrode 506, the separator 507, and the positive electrode 503 are stacked. FIG. 24B illustrates the negative electrodes 506, the separators 507, and the positive electrodes 503 that are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 24C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte 508 can be introduced later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, the electrolyte 508 (not illustrated) is introduced into the exterior body 509 from the inlet of the exterior body 509. The electrolyte 508 is preferably introduced in a reduced pressure atmosphere or in an inert atmosphere. Lastly, the inlet is sealed by bonding. In this manner, the laminated secondary battery 500 can be manufactured.

The negative electrode structure obtained in Embodiment 1, i.e., an electrolyte containing fluorine is used for the negative electrode 506, whereby the secondary battery 500 can have high capacity, high charge and discharge capacity, and excellent cycle performance.

This embodiment can be implemented in appropriate combination with any of the other embodiments.

### Embodiment 4

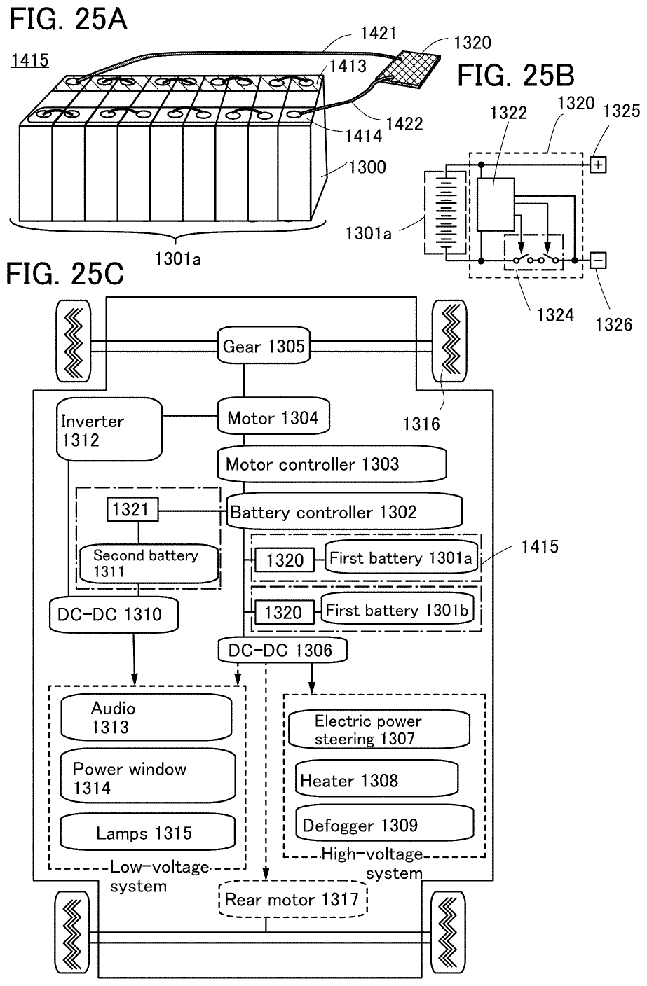

As described below, a secondary battery of one embodiment of the present invention can be provided in a moving vehicle such as an automobile, a train, or an aircraft. In this embodiment, an example different from the cylindrical secondary battery in FIG. 20D will be described. An example of application of a secondary battery to an electric vehicle (EV) will be described with reference to FIG. 25C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 21A or the stacked structure illustrated in FIG. 23A and FIG. 23B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 25A.

FIG. 25A illustrates an example in which nine rectangular secondary batteries 1300 constitute one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, the secondary batteries may be stored in a battery container box (also referred to as a housing). Since a vehicle is probably subjected to a vibration or a jolt from the outside (e.g., a road surface), the plurality of secondary batteries are preferably fixed by the fixing portions 1413 and 1414. or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off both an output transistor of a charging circuit and an interruption switch substantially at the same time.

FIG. 25B illustrates an example of a block diagram of the battery pack 1415 illustrated in FIG. 25A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (—IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage. Lead batteries have disadvantages compared with lithium-ion secondary batteries in that they have a larger amount of self-discharge and are more likely to degrade due to a phenomenon called sulfation. There is an advantage that the second battery 1311 can be maintenance-free when it uses a lithium-ion secondary battery; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from one or both of a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, an outlet of a charger or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

Mounting the secondary battery illustrated in FIG. 20D or FIG. 25A on vehicles can provide next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and can be favorably used in transport vehicles.

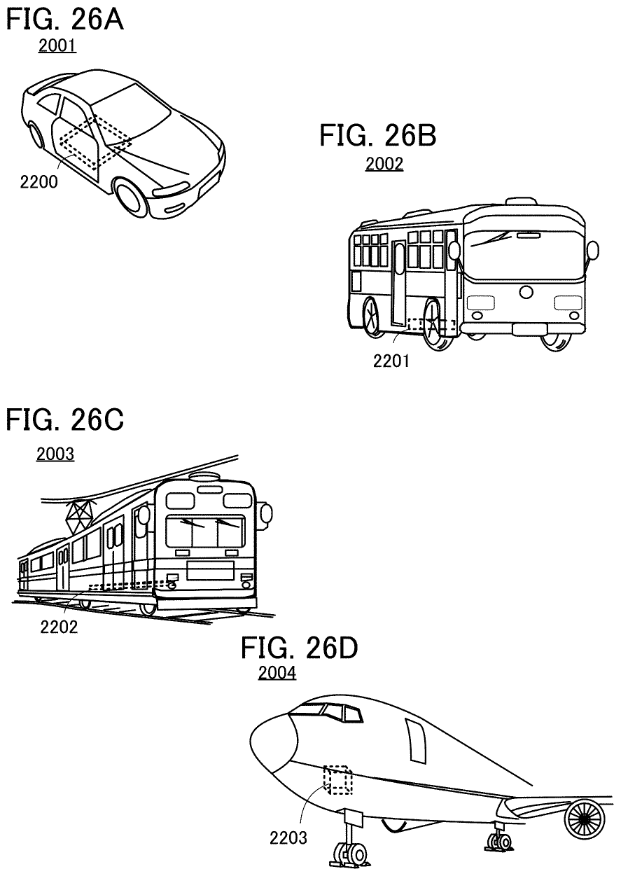

FIG. 26A to FIG. 26D illustrate examples of transport vehicles using one embodiment of the present invention. An automobile 2001 illustrated in FIG. 26A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery described as an example in Embodiment 4 is provided at one position or several positions. The automobile 2001 illustrated in FIG. 26A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from external charging equipment through one or more of a plug-in system, a contactless charging system, and the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a secondary battery incorporated in the automobile 2001. Charging can be performed by converting AC power into DC power through a converter such as an AC-DC converter.

Although not illustrated, the vehicle can include a power receiving device so as to be charged by being supplied with electric power from an above-ground power transmitting device in a contactless manner. For the contactless power feeding system, by fitting a power transmitting device in one or both of a road and a wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, one or both of an electromagnetic induction method and a magnetic resonance method can be used.

FIG. 26B illustrates a large transporter 2002 having a motor controlled by electric power, as an example of a transport vehicle. In the secondary battery module of the transporter 2002, a cell unit includes four secondary batteries with a voltage of 3.5 V or higher and 4.7 V or lower, and 48 cells are connected in series to have 170 V as the maximum voltage. A battery pack 2201 has a function similar to that in FIG. 26A except that the number of secondary batteries forming the secondary battery module of the battery pack 2201 or the like is different; thus the description is omitted.

FIG. 26C illustrates a large transport vehicle 2003 having a motor controlled by electricity as an example. In the secondary battery module of the transport vehicle 2003, 100 or more secondary batteries with a voltage of 3.5 V or higher and 4.7 V or lower are connected in series, and the maximum voltage is 600 V, for example. Thus, the secondary batteries are required to have few variations in the characteristics. With use of a secondary battery employing the negative electrode structure described in Embodiment 1, i.e., the structure including an electrolyte containing fluorine in a negative electrode, a secondary battery having stable battery characteristics can be manufactured and its high-volume production at low costs is possible in light of the yield. A battery pack 2202 has a function similar to that in FIG. 26A except that the number of secondary batteries forming the secondary battery module of the battery pack 2202 or the like is different; thus the detailed description is omitted.

FIG. 26D illustrates an aircraft 2004 having a combustion engine as an example. The aircraft 2004 illustrated in FIG. 26D can be regarded as a portion of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 26A except that the number of secondary batteries constituting the secondary battery module of the battery pack 2203 or the like is different; thus the detailed description is omitted.

This embodiment can be implemented in appropriate combination with any of the other embodiments.

### Embodiment 5

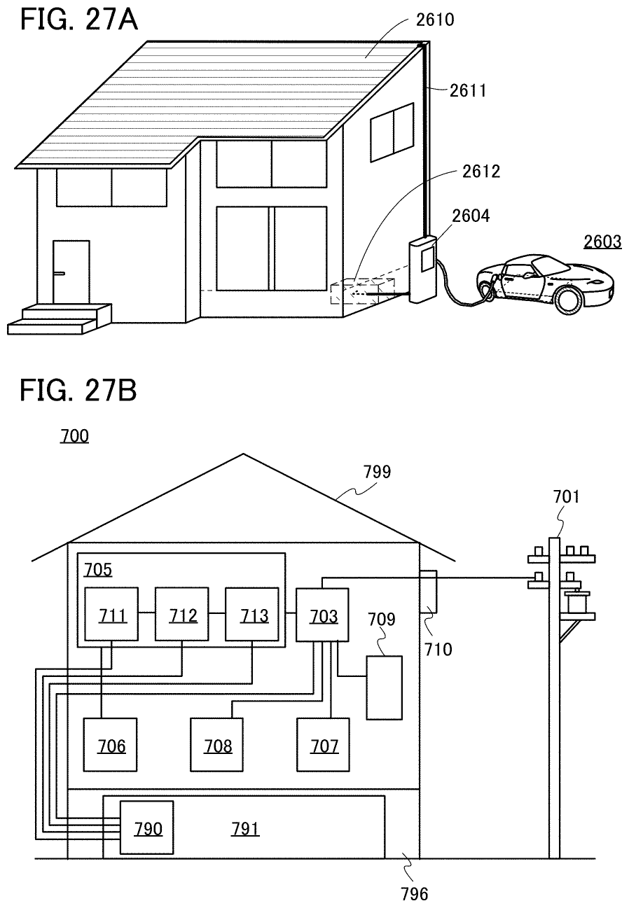

In this embodiment, examples in which the secondary battery of one embodiment of the present invention is mounted on a building will be described with reference to FIG. 27A and FIG. 27B.

A house illustrated in FIG. 27A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. The secondary battery included in the vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 27B illustrates an example of a power storage device 700 of one embodiment of the present invention. As illustrated in FIG. 27B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

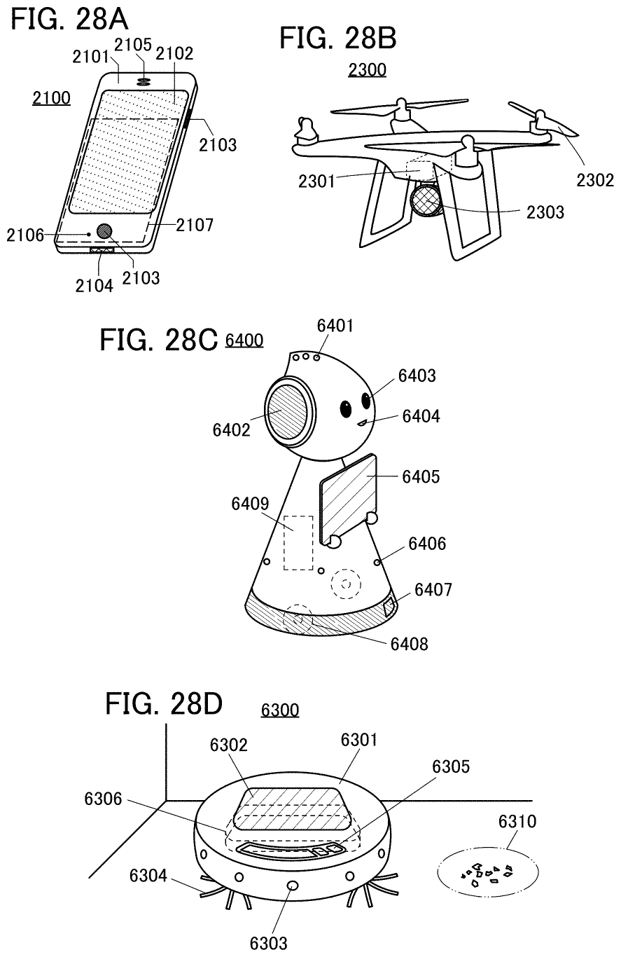

FIG. 28A illustrates an example of a mobile phone. A mobile phone 2100 includes a display portion 2102 set in a housing 2101, an operation button 2103, an external connection port 2104, a speaker 2105, a microphone 2106, and the like. The mobile phone 2100 includes a secondary battery 2107. The use of the secondary battery 2107 having the negative electrode structure described in Embodiment 1, i.e., the structure including an electrolyte containing fluorine in a negative electrode can provide high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by an operating system incorporated in the mobile phone 2100.

The mobile phone 2100 can employ near field communication based on a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, one or more selected from a human body sensor such as a fingerprint sensor, a pulse sensor, and a temperature sensor, a touch sensor, a pressure sensitive sensor, an acceleration sensor, and the like is preferably mounted, for example.

FIG. 28B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the negative electrode structure described in Embodiment 1, i.e., the structure including an electrolyte containing fluorine in a negative electrode has high energy density and a high degree of safety, and thus can be used safely for a long time over a long period of time and is suitable for the secondary battery used in the unmanned aircraft 2300.

FIG. 28C illustrates an example of a robot. A robot 6400 illustrated in FIG. 28C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user, using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery employing the negative electrode structure described in Embodiment 1, i.e., the structure including an electrolyte containing fluorine in a negative electrode has high energy density and a high degree of safety, and thus can be used safely for a long time over a long period of time and is suitable for the secondary battery 6409 included in the robot 6400.

FIG. 28D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the negative electrode structure described in Embodiment 1, i.e., the structure including an electrolyte containing fluorine in a negative electrode has high energy density and a high degree of safety, and thus can be used safely for a long time over a long period of time and is suitable for the secondary battery 6306 included in the cleaning robot 6300.

This embodiment can be implemented in appropriate combination with the other embodiments.

<Notes on Description of this Specification and the Like>

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (—) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, preferably less than or equal to 35 nm, further preferably less than or equal to 20 nm from the surface, for example. A plane generated by a split or a crack may also be referred to as a surface. In addition, a region in a deeper position than a surface portion is referred to as an inner portion.

In this specification and the like, the layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure of a composite oxide containing lithium and a transition metal belongs to the space group R-3m, and is not a spinel crystal structure but a crystal structure in which an ion of cobalt, magnesium, or the like is coordinated to six oxygen atoms and the cation arrangement has symmetry similar to that of the spinel crystal structure.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the depth of charge obtained when all the lithium that can be inserted and extracted is inserted is 0, and the depth of charge obtained when all the lithium that can be inserted and extracted in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a depth of charge of greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. Furthermore, a positive electrode active material with a charge depth of 0.06 or less or a positive electrode active material from which 90% or more of the charge capacity in a high-voltage charged state is discharged is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

### REFERENCE NUMERALS

201: electrode, 202: graphene compound, 204: vacancy, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte, 509: exterior body, 510: positive electrode lead electrode, 511: negative electrode lead electrode, 570: electrode, 570a: negative electrode, 570b: positive electrode, 571: current collector, 571a: negative electrode current collector, 571b: positive electrode current collector, 572: active material layer, 572a: negative electrode active material layer, 572b: positive electrode active material layer, 576: electrolyte, 581: electrolyte, 582: active material, 583: graphene compound, 584: acetylene black (AB), 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 811: positive electrode active material, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery

1. A graphene compound comprising a vacancy,
wherein the graphene compound comprises a plurality of carbon atoms and one or more fluorine atoms terminating the carbon atoms, and
wherein the vacancy is formed with the plurality of carbon atoms and the one or more fluorine atoms.

2. The graphene compound according to claim 1,
wherein the vacancy comprises a ring-shaped region composed of the plurality of carbon atoms and the one or more fluorine atoms, and
wherein the ring-shaped region is a 18- or more-membered ring.

3. The graphene compound according to claim 2,
wherein a lithium ion is capable of passing through the ring-shaped region.

4. The graphene compound according to claim 3,
wherein a change in a stabilization energy when the lithium ion passes through the vacancy is 1 eV or less.

5. The graphene compound according to claim 4,
wherein the stabilization energy is obtained by a Nudged Elastic Band method.

6. A secondary battery comprising:
an electrode comprising the graphene compound according to claim 1, and an active material; and
an electrolyte.

7. A moving vehicle comprising the secondary battery according to claim 6.

8. An electronic device comprising the secondary battery according to claim 6.

9. A secondary battery comprising:
an electrode,
wherein the electrode comprises a plurality of active materials and a graphene compound,
wherein the graphene compound comprises a vacancy,
wherein the vacancy has a 18- or more-membered ring in which at least one of a plurality of carbon atoms is terminated by fluorine,
wherein the graphene compound is provided as a bridge between a first one of the plurality of the active materials and a second one of the plurality of the active materials.

10. The secondary battery according to claim 9, wherein a lithium ion is capable of passing through the vacancy.

11. The secondary battery according to claim 9,
wherein the graphene compound comprises a first graphene layer and a second graphene layer,
wherein the first graphene layer comprises the vacancy,
wherein an energy barrier when a lithium ion diffuses in a region between the first graphene layer and the second graphene layer is lower than an energy barrier when the lithium ion passes through the vacancy.
